(19) United States
(12) Patent Application Publication
(10) Pub. No.: US 2026/0023825 A1
(43) Pub. Date: Jan. 22, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Kakuya YAMAMOTO, Hyogo (JP); Yuji UNAGAMI, Osaka (JP)

(21) Appl. No.: 19/339,648

(22) Filed: Sep. 25, 2025

Related U.S. Application Data
(63) Continuation of application No. PCT/JP2024/008255, filed on Mar. 5, 2024.
(60) Provisional application No. 63/458,195, filed on Apr. 10, 2023.

(51) Int. Cl. G06F 21/10; G06Q 10/30

(52) U.S. Cl. CPC G06F 21/1014; G06Q 10/30

(57) ABSTRACT

An information processing method includes: obtaining an address of a first distributed ledger in which a first non-fungible token (NFT) is stored, the first NFT being associated one-to-one with an item; and storing, in a second distributed ledger different from the first distributed ledger, a second NFT including the address of the first distributed ledger obtained, the second NFT being associated with life cycle information that is information regarding a life cycle of the item.

### CROSS REFERENCE TO RELATED APPLICATIONS

This is a continuation application of PCT International Application No. PCT/JP2024/008255 filed on Mar. 5, 2024, designating the United States of America, which is based on and claims priority of U.S. Provisional Patent Application No. 63/458,195 filed on Apr. 10, 2023. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

As an example of a method of evaluating the impact of human consumption activities on the environment, the life cycle of a product may be evaluated (see Non Patent Literature (NPL) 1).

### CITATION LIST

### Non Patent Literature

NPL 1: “Discovering All Environmental Effects: How Life Cycle Assessment with LCA Software Works” [online], iPoint-systems gmbh, [searched on Jan. 10, 2024], the Internet <URL: https://go.ipoint-systems.com/blog/discovering-all-environm ental-effects-how-life-cycle-assessment-with-Ica-software-works>

### SUMMARY

### Technical Problem

If the flow of items is not appropriately managed through the life cycle of a product, there is such a problem that it is impossible to make the effective use of resources.

Hence, the present disclosure provides an information processing method and the like that encourage the effective use of resources.

### Solution to Problem

An information processing method according to an aspect of the present disclosure includes: obtaining an address of a first distributed ledger in which a first non-fungible token (NFT) is stored; and storing, in a second distributed ledger different from the first distributed ledger, a second NFT including the address of the first distributed ledger obtained. The first NFT is associated one-to-one with an item, and the second NFT is associated with life cycle information that is information regarding a life cycle of the item.

Note that these general or specific aspects may be implemented using a system, a device, an integrated circuit, a computer program, or a computer-readable recording medium such as a compact disc read-only memory (CD-ROM), or any combination of systems, devices, integrated circuits, computer programs, and recording media.

### Advantageous Effects

According to the present disclosure, it is possible to encourage the effective use of resources.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the life cycle of an ordinary product.

FIG. 2 is a schematic diagram illustrating an example of the life cycle of a product in an embodiment.

FIG. 3 is a schematic diagram illustrating a general configuration of an information processing system in an embodiment.

FIG. 4 is a block diagram illustrating a functional configuration of a ledger server in an embodiment.

FIG. 5 is a block diagram illustrating a functional configuration of a ledger server in an embodiment.

FIG. 6 is an explanatory diagram illustrating the relation between two distributed ledgers in an embodiment.

FIG. 7 is an explanatory diagram illustrating an example of metadata on a trace NFT in an embodiment.

FIG. 8 is an explanatory diagram illustrating an example of metadata on a preferential NFT in an embodiment.

FIG. 9 is a sequence diagram illustrating generation processing of generating a right-of-use NFT in an embodiment.

FIG. 10 is a sequence diagram illustrating generation processing of generating a trace NFT corresponding to a disassembled item in an embodiment.

FIG. 11 is a sequence diagram illustrating transfer processing of transferring a trace NFT corresponding to a disassembled item in an embodiment.

FIG. 12 is a sequence diagram illustrating generation processing of generating a trace NFT corresponding to a recycled item in an embodiment.

FIG. 13 is a sequence diagram illustrating generation processing of generating a preferential NFT in an embodiment.

FIG. 14 is a sequence diagram illustrating purchasing processing of purchasing a recycled item using a preferential NFT in an embodiment.

FIG. 15 is a flowchart illustrating processing performed by a ledger system in processing of using a preferential NFT in an embodiment.

FIG. 16 is a sequence diagram illustrating an example of obtaining processing of obtaining pieces of detailed information in an embodiment.

FIG. 17 is an explanatory diagram illustrating an example of a display image displaying a preferential NFT in an embodiment.

FIG. 18 is an explanatory diagram illustrating an example of a display image displaying detailed information on a preferential NFT in an embodiment.

FIG. 19 is an explanatory diagram illustrating an example of a display image displaying an NFT in an embodiment.

FIG. 20 is a sequence diagram illustrating processing performed by an information processing system in a variation of an embodiment.

FIG. 21 is an explanatory diagram illustrating a data structure of a blockchain, which is an example of a distributed ledger.

FIG. 22 is an explanatory diagram illustrating a data structure of transaction data.

FIG. 23 is an explanatory diagram illustrating transaction data pertaining to the execution of a smart contract.

FIG. 24 is an explanatory diagram illustrating processing pertaining to execution of a smart contract.

FIG. 25 is an explanatory diagram illustrating structures of an NFT and metadata.

### DESCRIPTION OF EMBODIMENT

### Underlying Knowledge Forming Basis of the Present Disclosure

The present inventors found the following problems in the technique pertaining to the life cycle of a product, which has been described in the section “Background.”

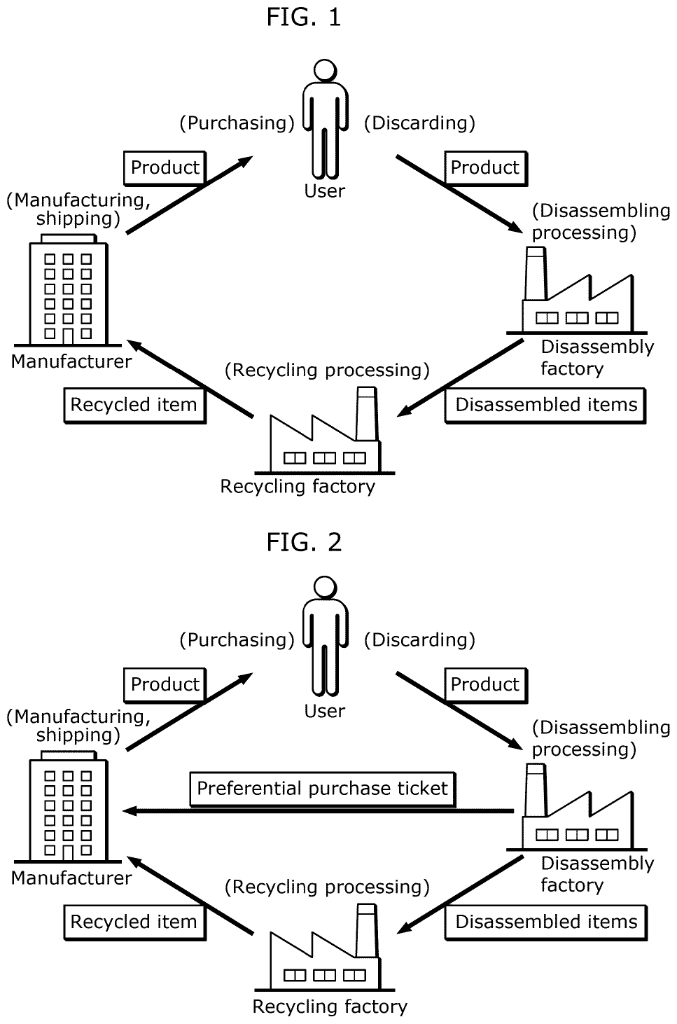

FIG. 1 is a schematic diagram illustrating the life cycle of an ordinary product. For example, the product is a product manufactured by a manufacturer. The product is specifically, but not limited to, a home appliance, an electronic device, or the like. As illustrated in FIG. 1, the product is manufactured and shipped by the manufacturer.

When the product is purchased by a user, the product is moved to the user who purchases the product and is used by the user. When the user discards the product, the product is moved to a disassembly factory and is subjected to disassembling processing in the disassembly factory. Through the disassembling processing, the product is disassembled into components or materials (specifically, a synthetic resin (will also be referred simply to as a resin), a metal, a substrate, etc.) that constitute the product. The components or materials will also be referred to as disassembled items.

The disassembled items are moved to a recycling factory and are subjected to recycling processing (specifically, processing including collecting, sorting, washing, crushing, melting, refining, etc.). The disassembled items are subjected to recycling processing to be recycled into items (also referred to as recycled items) that can be used to manufacture a new product. The recycled items are moved to the manufacturer and can be used to manufacture the new product.

In an appropriate circulation of the life cycle of a product, disassembled items are generated from the product discarded by a user, recycled items are generated from the disassembled items, and the recycled items are used to manufacture a new product. This enables the effective use of resources. Note that the effective use of resources decreases the amount of resources necessary to manufacture a new product, bringing about the effect of reducing the consumption of energy such as electricity necessary to prepare additional resources.

If the circulation of the life cycle of a product does not work appropriately, it is impossible to make the effective use of resources. For example, if a product discarded by a user is not passed to a disassembly factory, the product is not subjected to disassembling processing, and thus neither disassembled items nor recycled items are generated. As a result, no recycled items are used to manufacture a new product.

The present disclosure provides an information processing method and the like that encourage the effective use of resources.

Hereinafter, aspects of the disclosure derived from the content of the disclosure of the present description will be described by way of example, and the effects and the like derived from the aspects of the disclosure will be described.

(1) An information processing method including: obtaining an address of a first distributed ledger in which a first non-fungible token (NFT) is stored, the first NFT being associated one-to-one with an item; and storing, in a second distributed ledger different from the first distributed ledger, a second NFT including the address of the first distributed ledger obtained, the second NFT being associated with life cycle information that is information regarding a life cycle of the item.

According to the above aspect, it is possible to encourage the transaction of the first NFT, which corresponds to the handover of an item in the real world by using the transaction of the second NFT, which corresponds to the life cycle information on the item. This enables an appropriate circulation of the life cycle of the item (in other words, the contribution to realizing a circular economy), thus encouraging the effective use of resources. As seen from the above, the information processing method is capable of encouraging the effective use of resources.

(2) The information processing method according to (1), in which the item is a disassembled item generated by disassembling of a product, the first NFT is associated one-to-one with the disassembled item as the item, and the life cycle information includes information regarding the disassembling of the product.

According to the above aspect, it is possible to encourage the transaction of the first NFT, which corresponds to the handover of the disassembled item generated by disassembling of a product, by using the transaction of the second NFT, which corresponds to the life cycle information on the item. This enables an appropriate circulation of the life cycle of the product, thus encouraging the effective use of resources. As seen from the above, the information processing method is capable of encouraging the effective use of resources.

(3) The information processing method according to (2), in which the information regarding the disassembling of the product includes confidential information regarding a design of the product or confidential information regarding the disassembling of the product.

According to the above aspect, it is possible to appropriately disassemble the product by using, as the information regarding the disassembling of the product, the information regarding the designing of the product or the information regarding the disassembling of the product, which are managed as the confidential information. This enables an appropriate circulation of the life cycle of the product, thus encouraging the effective use of resources. As seen from the above, the information processing method is capable of encouraging the effective use of resources.

(4) The information processing method according to (2) or (3), in which the life cycle information further includes information indicating a recycled item generated by performing recycling processing on the disassembled item.

According to the above aspect, using the information indicating the recycled item as the life cycle information encourages the use of the recycled item, and it is thus possible to encourage the transaction of the item corresponding to the first NFT. Also, an appropriate circulation of the life cycle of the product is possible, thus encouraging the effective use of resources. As seen from the above, the information processing method is capable of encouraging the effective use of resources.

(5) The information processing method according to (4), in which the second NFT includes identification information identifying a third NFT stored in the first distributed ledger, the third NFT being associated one-to-one with the recycled item.

According to the above aspect, it is possible to encourage the transaction of the first NFT, which corresponds to the handover of an item in the real world by further using the transaction of the third NFT, which corresponds to the recycled item originating from the product. This enables an appropriate circulation of the life cycle of the product, thus encouraging the effective use of resources. As seen from the above, the information processing method is capable of encouraging the effective use of resources.

(6) The information processing method according to (5), in which when the third NFT is not yet stored in the first distributed ledger, the second NFT includes information indicating that the third NFT is not yet stored in the first distributed ledger.

According to the above aspect, it is possible to encourage the transaction of the first NFT by using the transaction of the second NFT even when the third NFT, which corresponds to the recycled item originating from the product, is not yet stored in the first distributed ledger. As seen from the above, the information processing method is capable of encouraging the effective use of resources.

(7) The information processing method according to any one of (2) to (6), further including causing processing of transferring the recycled item to an owner of the second NFT to be preferentially performed.

According to the above aspect, causing the processing of transferring the recycled item to the owner of the second NFT to be preferentially performed encourages the use of the recycled item when the owner of the second NFT manufactures a new product. This enables an appropriate circulation of the life cycle of the product, thus encouraging the effective use of resources. As seen from the above, the information processing method is capable of encouraging the effective use of resources.

(8) The information processing method according to any one of (1) to (7), in which the second NFT further includes: a type of the first distributed ledger; a token standard to which the first NFT conforms; an address of a smart contract used for accessing an NFT stored in the first distributed ledger; and a token identification (ID) of the first NFT in the first distributed ledger.

According to the above aspect, it is possible to encourage the transaction of the first NFT, which corresponds to the handover of the item in the real world, more easily by using the second NFT. Accordingly, the information processing method is capable of more easily encouraging the effective use of resources.

(9) An information processing system including: a first distributed ledger system that manages a first distributed ledger; and a second distributed ledger system that manages a second distributed ledger, in which the first distributed ledger system includes the first distributed ledger in which a first non-fungible token (NFT) is stored, the first NFT being associated one-to-one with an item, and the second distributed ledger system: obtains an address of the first distributed ledger; and stores, in the second distributed ledger different from the first distributed ledger, a second NFT including the address of the first distributed ledger obtained, the second NFT being associated with life cycle information that is information regarding a life cycle of the item.

According to the above aspect, the same advantageous effects as those produced by the above-described information processing method are produced.

(10) A program that causes one or more computers to execute the information processing method according to (1).

According to the above aspect, the same advantageous effects as those produced by the above-described information processing method are produced.

Note that these general and specific aspects may be implemented using a system, a device, an integrated circuit, a computer program, or a computer-readable recording medium such as a CD-ROM, or any combination of systems, devices, integrated circuits, computer programs, or computer-readable recording media.

Hereinafter, an exemplary embodiment will be specifically described with reference to the accompanying Drawings.

Note that each of the exemplary embodiments described below shows a general or specific example. The numerical values, shapes, materials, constituent elements, the arrangement and connection of the constituent elements, steps, the processing order of the steps etc. shown in the following exemplary embodiments are mere examples, and therefore do not limit the present disclosure.

Furthermore, among the constituent elements in the following exemplary embodiments, those not recited in any one of the independent claims representing the most generic concepts are described as optional constituent elements.

### Embodiment

In the present embodiment, an information processing method and an information processing system that encourage the effective use of resources will be described.

FIG. 2 is a schematic diagram illustrating an example of the life cycle of a product in the present embodiment.

The example of the life cycle of the product illustrated in FIG. 2 is the life cycle of a product illustrated in FIG. 1 to which the provision of a preferential purchase ticket from a disassembly factory to a manufacturer is added.

The preferential purchase ticket is an example of an embodied right to preferentially purchase a recycled item generated from disassembled items generated through disassembling processing on the product (also referred to as a “recycled item originating from the product”). Note that the preferential purchase ticket is an example of information that encourages the circulation of the life cycle of the product. Note that preferential purchasing includes, for example, purchasing an item earlier than another party that intends to purchase an identical item or purchasing the identical item at a lower price than the other party.

When the disassembly factory performs disassembling processing on a discarded product, the disassembly factory provides a preferential purchase ticket to a manufacturer that manufactures the product. Obtaining the preferential purchase ticket from the disassembly factory, the manufacturer can preferentially purchase a recycled item originating from the product, which is manufactured by the manufacturer itself, using the preferential purchase ticket. This enables the manufacturer to manufacture a product with an advantage and provide the product to a market. The manufacturer can be motivated to appropriately control the circulation of the life cycle of the product and can thus contribute to making the effective use of resources. Appropriately controlling the circulation of the life cycle can include, for example, making the disassembling processing easy or designing the product to be easily subjected to the disassembling processing.

Note that the preferential purchase ticket may be associated with the degree of a priority in purchasing the recycled item. In the case where the disassembly factory relatively easily performs the disassembling processing on the product, the disassembly factory may provide the manufacturer with the preferential purchase ticket with a priority to which a relatively high degree is set. In such a manner, the manufacturer can be motivated to provide a product that is even more easily subjected to the disassembling processing and can thus contribute even more to the effective use of resources.

Note that the preferential purchase ticket can be considered to indicate a reward for manufacturing a product that can be subjected to the disassembling processing or recycling processing. In the case where the preferential purchase ticket is associated with a priority, the degree of the priority can be considered to indicate how high the reward is.

Note that, as described above, the preferential purchase ticket is an example of an item that embodies a right to preferentially purchase a recycled item generated from a disassembled item. The preferential purchase ticket may be an idea representing the right. In this case, the preferential purchase ticket may be expressed as a “preferential purchase right.”

Note that the term “purchasing” in the present description can be reworded as “inheriting”. The term “inheriting” may be inheritance for compensation or inheritance without compensation. The term “inheriting” can be reworded as “handover” by switching parties on both sides of the inheritance.

An information processing system that appropriately handles a preferential purchase ticket in the life cycle of a product will be described below.

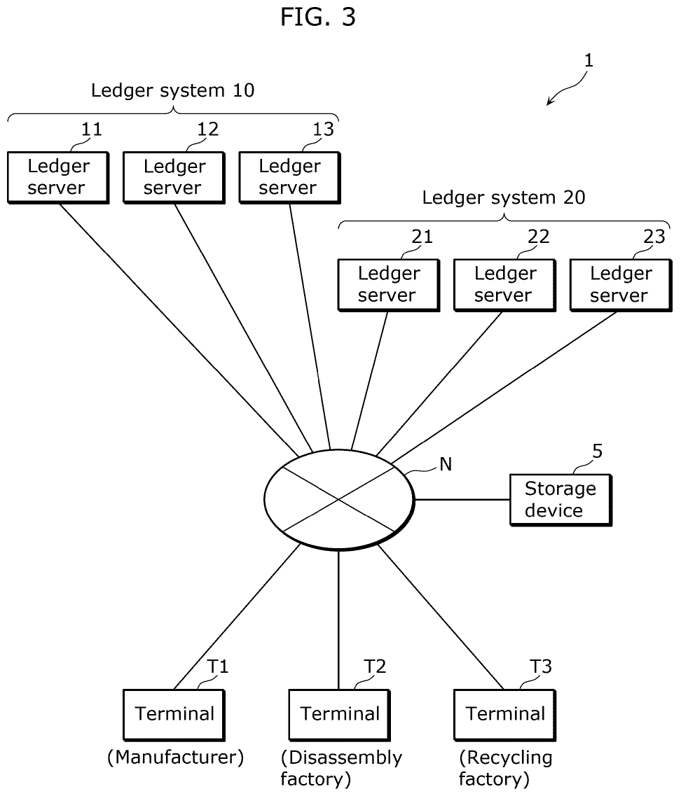

FIG. 3 is a schematic diagram illustrating the general configuration of information processing system 1 in the present embodiment. Information processing system 1 is an example of a system that encourages the effective use of resources.

As illustrated in FIG. 3, information processing system 1 includes ledger system 10 and ledger system 20. Information processing system 1 is connected to storage device 5, and terminals T1, T2, and T3. Note that information processing system 1 may further include storage device 5, or terminal T1, T2, or T3. The devices are connected to network N to be capable of performing communication over network N.

Ledger system 10 is an information processing system that stores information by means of a distributed ledger (also referred to as a first distributed ledger system). The distributed ledger included in ledger system 10 stores the history of generating a non-fungible token (NFT) associated with an item in the real world, the history of transactions of the NFT, and the like. The NFT is an NFT with which the generation or transactions of the item in the real world are traced on the distributed ledger. The NFT will also be referred to as a trace NFT. The distributed ledger included in ledger system 10 will also be referred to as a tracing chain (see FIG. 6). Note that the correspondence between the item in the real world and the NFT is, for example, one-to-one, and the description will be given of, but not limited to, the case by way of example.

Using the distributed ledger, ledger system 10 can execute processing by means of a smart contract. Through the processing executed by means of the smart contract, ledger system 10 can generate the trace NFT and conduct the transactions with the trace NFT.

Ledger system 10 includes ledger servers 11, 12, and 13 (also referred to as ledger server 11 and the like) as a group of servers that store the distributed ledger. When at least one of ledger server 11 and the like receives transaction data, the transaction data is shared among all of ledger server 11 and the like and stored in the distributed ledger. Note that the number of ledger servers included in the group of servers is not limited to three. The number may be two or greater than three.

Ledger server 11 is a server being a computer that stores and manages the distributed ledger. Ledger server 11 stores the distributed ledger and updates the distributed ledger while synchronizing the distributed ledger with other ledger servers (specifically, with ledger servers 12 and 13).

Each of ledger servers 12 and 13 is the same server as ledger server 11 and operates independently of ledger server 11.

Note that ledger system 10 may include a plurality of ledger systems for different items. Specifically, ledger system 10 may include a ledger system for resin, a ledger system for metal, and a ledger system for a substrate. Here, the ledger system for resin includes a distributed ledger that stores the history of generating a trace NFT associated one-to-one with the resin, the history of transactions with the trace NFT, and the like. The same applies to the metal or the substrate.

Ledger system 20 is an information processing system that stores information by means of a distributed ledger (also referred to as a second distributed ledger system). Ledger system 20 is a system different from ledger system 10. The distributed ledger included in ledger system 20 stores the history of generating an NFT associated with information regarding the life cycle of a product (also referred to as life cycle information), the history of transactions with the NFT, and the like. The NFT embodies, for example, information for encouraging the circulation of the life cycle of the product (equivalent to the preferential purchase ticket) in the form of an NFT. The NFT will also be referred to as a preferential NFT. The distributed ledger included in ledger system 20 will also be referred to as a circulation encouraging chain (see FIG. 6).

Using the distributed ledger, ledger system 20 can execute processing by means of a smart contract. Through the processing executed by means of the smart contract, ledger system 20 can generate the preferential NFT and conduct transactions with the preferential NFT.

Ledger system 20 includes ledger servers 21, 22, and 23 (also referred to as ledger server 21 and the like) as a group of servers that store the distributed ledger. When at least one of ledger server 21 and the like receives transaction data, the transaction data is shared among all of ledger server 21 and the like and stored in the distributed ledger. Note that the number of ledger servers included in the group of servers is not limited to three. The number may be two or greater than three.

Ledger server 21 is a server being a computer that stores and manages the distributed ledger. Ledger server 21 stores the distributed ledger and updates the distributed ledger while synchronizing the distributed ledger with other ledger servers (specifically, with ledger servers 22 and 23).

Each of ledger servers 22 and 23 is the same server as ledger server 21 and operates independently of ledger server 21.

Note that ledger system 20 may include a plurality of ledger systems for different manufacturers or products. Specifically, ledger system 20 may include a ledger system for a product from manufacturer A, a ledger system for a product from manufacturer B, and a ledger system for manufacturer C. Here, the ledger system for a product from manufacturer A includes a distributed ledger that stores the history of generating a preferential NFT associated with life cycle information on the product from manufacturer A, the history of transactions with the preferential NFT, and the like. The same applies to manufacturer B or manufacturer C.

Storage device 5 is a storage device storing data. Storage device 5 can be accessed (specifically subjected to reading or writing) by ledger system 10 or 20, or terminal T1, T2, or T3 over network N. There may be one or more storage devices 5. Storage device 5 can store various types of information including disassembling information (described later). The information stored in storage device 5 can be used as metadata on an NFT generated by ledger system 10 or 20.

Note that, in the case where storage device 5 stores disassembling information that can be accessed by only a device with a right of use, storage device 5 can be configured such that, when receiving an access request for the disassembling information, storage device 5 determines whether the transmitter of the access request has the right of use, and such that storage device 5 permits the access only when the transmitter of the access request has the right of use. Storage device 5 can determine that the transmitter of the access request has the right of use in the case where the transmitter of the access request owns a right-of-use NFT at the time when storage device 5 receives the access request.

Terminal T1 is an information processing device used by a user of a manufacturer. Terminal T1 includes a processor (e.g., a central processing unit (CPU), the same applies below), a memory, a user interface (a display screen, a speaker, or a touch panel, etc.; the same applies below), and a communication interface. Using the user interface or the communication interface, terminal T1 can receive an input of information and can generate and display information, output information in the form of sound, or transmit and receive information. Terminal T1 can be, for example, a personal computer, a tablet, or a smartphone. The content of specific processing by terminal T1 will be described in detail later.

Terminal T2 is an information processing device used by a user of the disassembly factory. Terminal T2 includes a processor, a memory, a user interface, and a communication interface. Using the user interface or the communication interface, terminal T2 can receive an input of information and can generate and display information, output information in the form of sound, or transmit and receive information. Terminal T2 can be, for example, a personal computer, a tablet, or a smartphone. The content of specific processing by terminal T2 will be described in detail later.

Terminal T3 is an information processing device used by a user of a recycling factory. Terminal T3 includes a processor, a memory, a user interface, and a communication interface. Using the user interface or the communication interface, terminal T3 can receive an input of information and can generate and display information, output information in the form of sound, or transmit and receive information. Terminal T3 can be, for example, a personal computer, a tablet, or a smartphone. The content of specific processing by terminal T3 will be described in detail later.

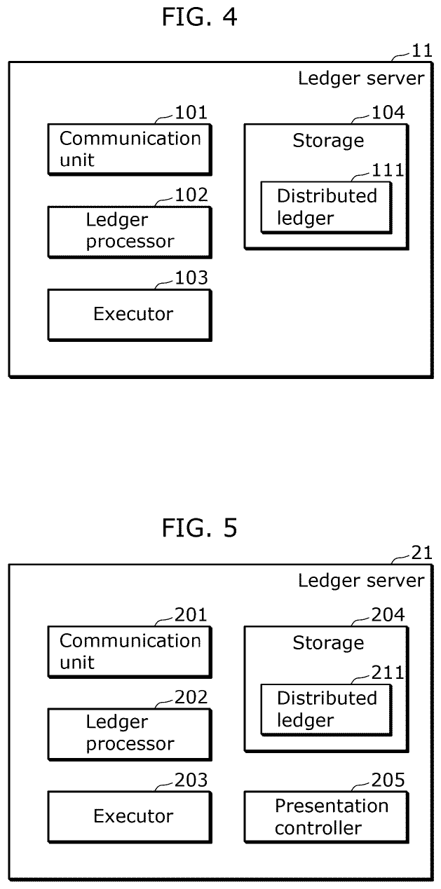

FIG. 4 is a block diagram illustrating a functional configuration of ledger server 11 in the present embodiment.

Ledger server 11 includes communication unit 101, ledger processor 102, executor 103, and storage 104, as functional units. At least some of the functional units included in ledger server 11 are implemented by a processor (e.g., a CPU) included in ledger server 11 executes a program using a memory.

Communication unit 101 is a communication interface that is connected to network N so as to perform communication. Communication unit 101 may be a communication interface conforming to a wired communication standard (e.g., Ethernet (registered trademark), etc.), a communication interface conforming to a wireless communication standard (e.g., Wi-Fi (registered trademark), etc., or a mobile communications system (3G, 4G, or 5G, etc.)). Communication unit 101 is used when a functional unit included in ledger server 11 communicates with another device.

Ledger processor 102 executes processing pertaining to distributed ledger 111 or transaction data. Specifically, when receiving transaction data from ledger system 20, or terminal T1, T2, or T3, or the like, ledger processor 102 performs control such that the digital signature included in the received transaction data is verified, and such that when the verification succeeds, the transaction data is stored in distributed ledger 111 stored in storage 104. To store the transaction data in distributed ledger 111, ledger processor 102 performs control such that a block including the transaction data to be stored is generated, and such that the block is stored in distributed ledger 111 when a consensus about the generated block is reached with ledger processor 102 of each of ledger servers 12 and 13, which are the other ledger servers.

Executor 103 executes information processing. For example, using distributed ledger 111, executor 103 can execute the information processing by executing a smart contract. Note that, in the case where no smart contract is used, executor 103 executes the information processing according to a conventional program code.

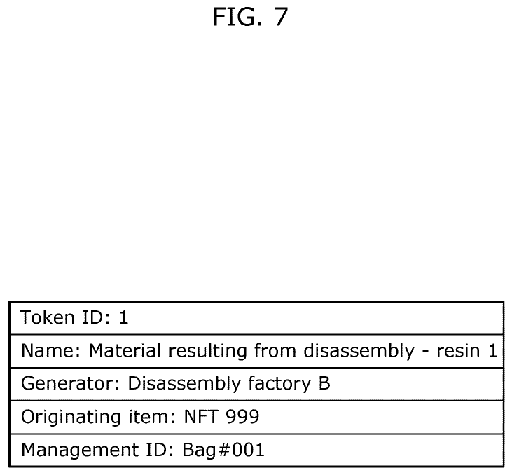

As the information processing, executor 103 executes the processing of generating a trace NFT by means of a smart contract. The trace NFT is associated one-to-one with an item in the real world. The trace NFT includes, as metadata, trace information that includes the type of the item associated with the trace NFT, the number of items associated with the trace NFT, or the like. Metadata in a trace NFT will be described in detail later (see FIG. 7).

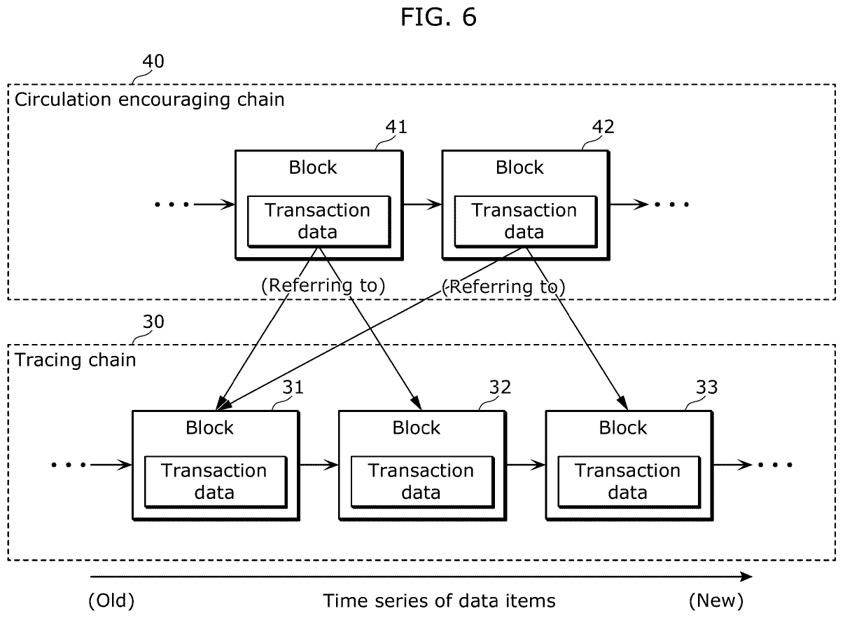

FIG. 5 is a block diagram illustrating a functional configuration of ledger server 21 in the present embodiment.

Ledger server 21 includes communication unit 201, ledger processor 202, executor 203, storage 204, and presentation controller 205, as functional units. At least some of the functional units included in ledger server 21 are implemented by a processor (e.g., a CPU) included in ledger server 21 executes a program using a memory.

Communication unit 201 is a communication interface that is connected to network N so as to perform communication. Communication unit 201 may be a communication interface conforming to a wired communication standard (e.g., Ethernet (registered trademark), etc.), a communication interface conforming to a wireless communication standard (e.g., Wi-Fi (registered trademark), etc., or a mobile communications system (3G, 4G, or 5G, etc.)). Communication unit 201 is used when functional units included in ledger server 21 communicate with another device.

Ledger processor 202 executes processing pertaining to distributed ledger 211 or transaction data. Specifically, when receiving transaction data from ledger system 10, or terminal T1, T2, or T3, or the like, ledger processor 202 performs control such that the digital signature included in the received transaction data is verified, and such that when the verification succeeds, the transaction data is stored in distributed ledger 211 stored in storage 204. To store the transaction data in distributed ledger 211, ledger processor 202 performs control such that a block including the transaction data to be stored is generated, and such that the block is stored in distributed ledger 211 when a consensus about the generated block is reached with ledger processor 202 of each of ledger servers 22 and 23, which are the other ledger servers.

Executor 203 executes information processing. For example, using distributed ledger 211, executor 203 can execute the information processing by executing a smart contract. Note that, in the case where no smart contract is used, executor 203 executes the information processing according to a conventional program code.

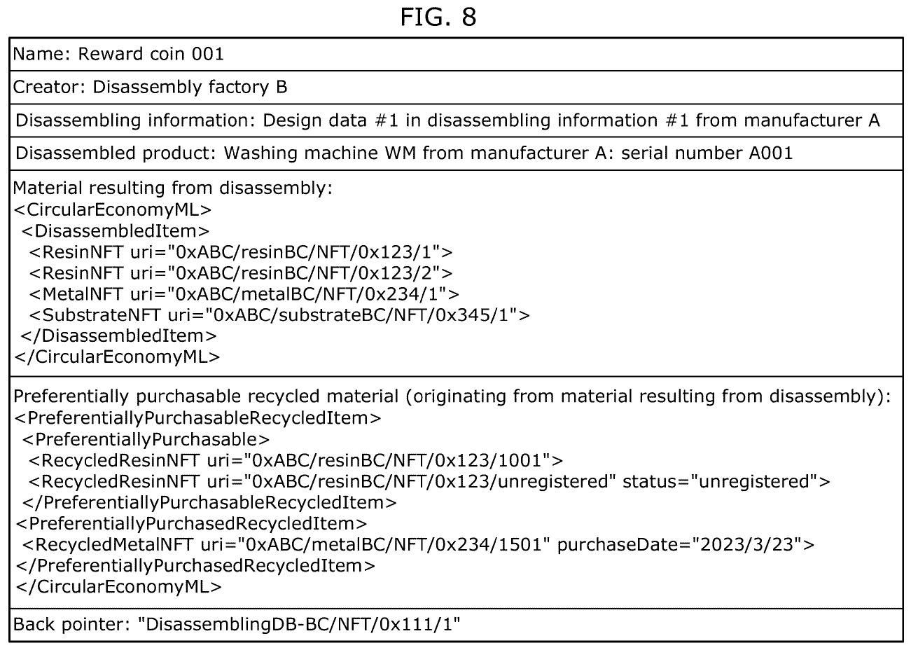

As the information processing, executor 203 executes the processing of generating a preferential NFT by means of a smart contract. The preferential NFT is an NFT associated with life cycle information and includes the life cycle information as metadata. The metadata on the preferential NFT will be described in detail later (see FIG. 8).

Storage 204 is a storage device storing information. Storage 204 stores distributed ledger 211. Storage 204 is implemented with a nonvolatile storage device (a solid state drive (SSD) or a hard disk drive (HDD)) or the like.

Distributed ledger 211 stores data having a structure in which blocks each including one or more pieces of transaction data are linked to form a chain. One or more pieces of transaction data stored in distributed ledger 211 include transaction data including the contract code of a smart contract, transaction data including instructions to execute the smart contract, or transaction data including the other information.

Presentation controller 205 performs control of causing a terminal to present information regarding an NFT (a preferential NFT or a right-of-use NFT, etc.). For example, presentation controller 205 transmits information regarding an NFT owned by a manufacturer to terminal T1 of a user of the manufacturer, thus performing control of causing terminal T1 to present the information to the user. Presenting the information regarding the NFT by terminal T1 can include displaying the information on the display screen or outputting the information from the speaker in the form of sound.

FIG. 6 is an explanatory diagram illustrating the relation between two distributed ledgers in the present embodiment. FIG. 7 is an explanatory diagram illustrating an example of metadata on a trace NFT in the present embodiment. FIG. 8 is an explanatory diagram illustrating an example of metadata on a preferential NFT in the present embodiment. With reference to FIG. 6 to FIG. 8, distributed ledgers and NFTs in the present embodiment will be described.

FIG. 6 illustrates, as the two distributed ledgers, tracing chain 30 and circulation encouraging chain 40. Tracing chain 30 is managed by ledger system 10, and circulation encouraging chain 40 is managed by ledger system 20.

For example, tracing chain 30 includes blocks 31 32, and 33. Blocks 31, 32, and 33 each include transaction data that stores the history of generating a trace NFT, the history of transactions of with the trace NFT, and the like.

For example, in the case where a new item is generated in the real world, a trace NFT is newly generated being associated one-to-one with the generated item by terminal T1, T2, or T3 and managed in tracing chain 30. Generating the new item can include, for example, manufacturing a new product by a manufacturer, generating a disassembled item by the disassembly factory performing the disassembling processing on a product, or generating a recycled item by the recycling factory performing the recycling processing on a disassembled item.

Note that there may be a many-to-one correspondence between items in the real world and a trace NFT or a one-to-many correspondence between an item in the real world and trace NFTs. For example, ten disassembled items may be associated with one trace NFT. One product or disassembled item may be associated with a plurality of trace NFTs. One product or disassembled item may be associated with different trace NFTs in different time periods, or one product or disassembled item may be associated with different trace NFTs by different organizations.

An example of metadata on a trace NFT is illustrated in FIG. 7.

As illustrated in FIG. 7, metadata on a trace NFT includes a token ID, a name, a generator, an originating item, a process, and a management ID.

The token ID is the token ID of the trace NFT.

The name indicates the name of an item associated with the trace NFT. For example, the name may be a name given by a party that generates the item.

The generator indicates a party that generates the item associated with the trace NFT.

The originating item is the information indicating an item from which the item associated with the trace NFT is generated. For example, the originating item can be the token ID of a trace NFT associated with the item from which the item associated with the trace NFT is generated.

The management ID is identification information for management that is given to the item associated with the trace NFT. For example, the management ID may be a management ID given by a party that generates the item. The management ID may be the same information as identification information that is given in a manner that the identification information can be seen on the exterior of the item. For example, the management ID can be information (a number, etc.) written on the exterior surface of a bag or a box that contains the item.

The metadata on a trace NFT illustrated in FIG. 7 indicates the resin that is a disassembled item generated through the disassembling processing performed in disassembly factory B on an item associated with a trace NFT of which the token ID is 999. The metadata also indicates that the resin is given the name “Material resulting from disassembly-resin 1” and is contained in a bag indicated as “Bag #001.”

Referring back to FIG. 6, circulation encouraging chain 40 stores an NFT associated with life cycle information (i.e., a preferential NFT). As an example of blocks included in circulation encouraging chain 40, blocks 41 and 42 are illustrated. Blocks 41 and 42 each include transaction data that stores the history of generating a preferential NFT, the history of transactions of the preferential NFT, and the like.

A preferential NFT is associated with one or more items (specifically, one or more products, disassembled items, or recycled items) that appear in the life cycle of a product. The association is established by referring to one or more trace NFTs corresponding to the one or more items (the one or more products, disassembled items, or recycled items). The preferential NFT includes reference to one or more trace NFTs.

For example, in the case where a product is disassembled, and a disassembled item is generated, a preferential NFT is generated based on a request from a party that performs the disassembling. The preferential NFT is transferred from the party that disassembles the product to a manufacturer that has manufactured the product.

An example of metadata on a preferential NFT is illustrated in FIG. 8. Metadata in a preferential NFT includes life cycle information (in other words, preferential information).

As illustrated in FIG. 8, metadata on a preferential NFT includes pieces of information including a name, a creator, disassembly information, a disassembled product, a material resulting from disassembly, a preferentially purchasable recycled item, and a back pointer.

The name indicates the name of the preferential NFT.

The creator indicates the creator of the preferential NFT. For example, a creator can be a generator who generates a disassembled item by performing the disassembling processing on the product.

The disassembling information is information regarding the disassembling of the product. For example, the disassembling information can be information regarding the design of the product (also referred to as design information) or information regarding the disassembling of the product. The disassembling information can be confidential information.

The disassembled product is information for identifying the product that is disassembled. The disassembled product can include a manufacturer that manufactures the product, the product number and the serial number of the product, and the like.

The material resulting from disassembly is the information indicating a disassembled item generated through the disassembling of the product. Specifically, the material resulting from disassembly includes identification information on a trace NFT corresponding to the disassembled item. Note that the identification information on the trace NFT is specifically the URI of the trace NFT and functions as a reference to the trace NFT. The same applies hereinafter.

The preferentially purchasable recycled item is the information indicating a recycled item that is generated through the recycling processing performed on a disassembled item generated by the disassembling of the product. The preferentially purchasable recycled item indicates a recycled item that can be preferentially purchased by a party that owns the preferential NFT. Specifically, the “preferentially purchasable recycled item” includes identification information on a trace NFT corresponding to the recycled item. Note that, in the case where the trace NFT corresponding to the recycled item is not yet stored in tracing chain 30, the “preferentially purchasable recycled item” includes the information indicating that the trace NFT corresponding to the recycled item is not yet stored in tracing chain 30.

The back pointer indicates identification information on the preferential NFT including the metadata. The back pointer can be used to refer to the preferential NFT by a process in which the metadata is processed.

The metadata on a preferential NFT illustrated in FIG. 8 is an example of metadata on a preferential NFT that is generated when a washing machine from manufacturer A is disassembled.

The metadata on a preferential NFT illustrated in FIG. 8 indicates that the name of the preferential NFT is “Reward coin 001,” and that disassembly factory B disassembles the disassembled product “Washing machine WM from manufacturer A: serial number A001” using the disassembling information “Design data #1 in disassembling information #1 from manufacturer A.”

In FIG. 8, the material resulting from disassembly is written in Circular Economy ML, which is a markup language in the extensible Markup Language (XML) format as an example.

Specifically, “DisassembledItem” tag includes, as its subordinate tags, “ResinNFT” tags, “MetaINFT” tag, and “SubstrateNFT” tag.

In each of “ResinNFT” tags, identification information on a trace NFT corresponding to a resin generated through the disassembling processing (also referred to as a resin NFT) is written in the form of a uniform resource identifier (URI). The identification information on the trace NFT includes the address of a distributed ledger storing the trace NFT, the type of the distributed ledger storing the trace NFT, the token standard to which the trace NFT conforms, the address of a smart contract used for accessing the trace NFT, and the token ID of the trace NFT in the distributed ledger storing the trace NFT. For example, the identification information on the trace NFT can be information into which the pieces of information are inserted and linked together with delimiters (e.g., slashes) inserted therebetween. The URI of the resin NFT is, for example, “0xABC/resinBC/NFT/0x123/1.”

Note that the token ID of the trace NFT in the distributed ledger storing the trace NFT may be undetermined. In this case, the information indicating that the token ID is undetermined is set as the token ID of the trace NFT.

The same applies to “MetaINFT” tag and “SubstrateNFT” tag.

In FIG. 8, the preferentially purchasable recycled item is written in Circular Economy ML, which is the markup language in the XML format, as with the written material resulting from disassembly.

Specifically, “PreferentiallyPurchasableRecycledItem” tag includes, as its subordinate tags, “RecycledResinNFT” tags. In addition, “Preferentially Purchased RecycledItem” tag includes “Recycled MetaINFT” tag as its subordinate tag.

In each of “RecycledResinNFT” tags, which is the tag subordinate to “PreferentiallyPurchasableRecycledItem” tag, identification information on a trace NFT corresponding to a recycled resin that is a resin generated through the recycling processing performed on the resin generated through the disassembling processing is written in the form of a URI.

The identification information on the trace NFT is, in principle, similar to the pieces of identification information on the trace NFTs in “DisassembledItem” tag. In the case where the recycled resin is not yet registered, the identification information on the trace NFT can include the information indicating “unregistered.” Specifically, a part of the identification information on the trace NFT in the distributed ledger storing the trace NFT is “unregistered.” In addition, the status attribute in “RecycledResinNFT” tag “unregistered.”

In “RecycledMetaINFT” tag, which is the tag subordinate to “PreferentiallyPurchased RecycledItem” tag, identification information on a trace NFT corresponding to a recycled metal that is a metal generated through the recycling processing performed on a metal generated through the disassembling processing is written in the form of a URI.

The identification information on the trace NFT is, in principle, similar to the pieces of identification information on the trace NFTs in “DisassembledItem” tag. In the case where the recycled metal has already been purchased, the date of the purchase is written as the attribute of “purchaseDate” element in the identification information on the trace NFT.

Processes executed by information processing system 1 will be described below. Specifically, as the processing executed by information processing system 1, the generation processing of generating a right-of-use NFT, the generation processing of generating a trace NFT corresponding to a disassembled item, the transfer processing of transferring a recycled item, the generation processing of generating a trace NFT corresponding to the recycled item, the generation processing of generating a preferential NFT, and the handover processing of handover of the recycled item using the preferential NFT will be described.

Note that such an expression that a device transmits information or data to ledger system 10 means that the device transmits the information or the data to one of ledger server 11 and the like included in ledger system 10 (e.g., ledger server 11). In addition, such an expression that ledger system 10 transmits information or data to a device means that one of ledger server 11 and the like included in ledger system 10 (e.g., ledger server 11) transmits the information or the data. The same applies to ledger system 20.

### (Generation Processing of Generating Right-of-Use NFT)

The generation processing of generating a right-of-use NFT will be described below. The right-of-use NFT is an NFT equivalent to a right to use disassembling information. For example, the right-of-use NFT is an NFT generated by a manufacturer that manufactures a product. The right-of-use NFT is owned by the disassembly factory that disassembles the product. The disassembling information can be used by a party that owns the right-of-use NFT. A party that does not have the right-of-use NFT is not permitted to use the right-of-use NFT. Using the disassembling information can include referring to the disassembling information or changing a part or all of the disassembling information.

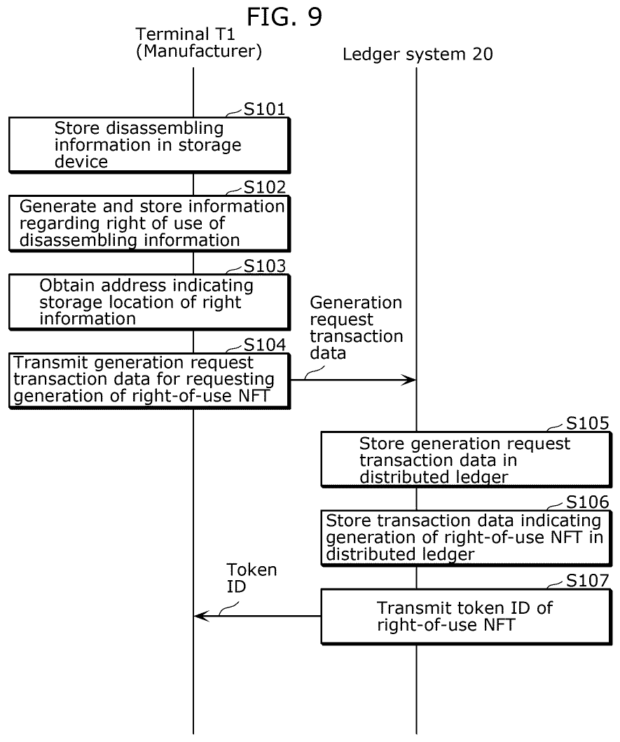

FIG. 9 is a sequence diagram illustrating the generation processing of generating a right-of-use NFT in the present embodiment. A series of steps illustrated in FIG. 9 is executed before a product is disassembled in the disassembly factory.

In step S101, terminal T1 stores disassembling information in storage device 5. The stored disassembling information may be disassembling information that has already been stored in terminal T1, may be disassembling information that is input into terminal T1, or may be disassembling information that terminal T1 obtains from another information processing device over network N. Note that the disassembling information stored in storage device 5 is managed such that the disassembling information can be accessed by only a party that owns a right to use the disassembling information (also referred to as a right of use).

In step S102, terminal T1 generates information regarding the right of use of the disassembling information obtained in step S101 (also referred to as right information) and stores the right information in storage device 5. The right information is the information indicating a device that can use the disassembling information.

In step S103, terminal T1 obtains the address indicating a storage location where the right information is stored in step S102. The address is, for example, a URI. More specifically, the address can be a URL.

In step S104, terminal T1 transmits generation request transaction data for requesting the generation of the right-of-use NFT to ledger system 20. Ledger system 20 receives the transmitted generation request transaction data. The generation request transaction data includes the address that is obtained in step S103 and indicates the storage location of the right information.

In step S105, ledger system 20 stores the generation request transaction data received in step S104 in distributed ledger 211.

In step S106, ledger system 20 generates the right-of-use NFT using the generation request transaction data in response to the storing of the generation request transaction data in distributed ledger 211 in step S105. Generating the right-of-use NFT includes storing transaction data indicating the generation of the right-of-use NFT in distributed ledger 211. Metadata in the right-of-use NFT includes the address indicating the storage location of the right information. The owner of the right-of-use NFT is the disassembly factory.

In step S107, ledger system 20 transmits the token ID of the right-of-use NFT generated in step S106 to terminal T1. Terminal T1 receives the transmitted token ID. Note that ledger system 20 may perform the transmission of the token ID as a response to the reception of the generation request transaction data in step S104.

Note that the processing in steps S106 to S107 may be executed by means of a smart contract based on the storage of the generation request transaction data in distributed ledger 211 in step S105. In this case, the generation request transaction data includes instructions to execute the smart contract for executing the processing, and executor 203 can execute the processing according to the instructions in response to the storing of the generation request transaction data in distributed ledger 211 (step S105).

The series of steps illustrated in FIG. 9 brings about the state where the right-of-use NFT is generated and owned by the disassembly factory.

### (Generation Processing of Generating Trace NFT Corresponding to Disassembled Item)

The generation processing of generating a trace NFT corresponding to a disassembled item will be described below. Here will be described the processing of generating, when the disassembled item is generated through the disassembling of a product in the disassembly factory, a trace NFT corresponding to the disassembled item in response to a request from terminal T2 of a user of the disassembly factory.

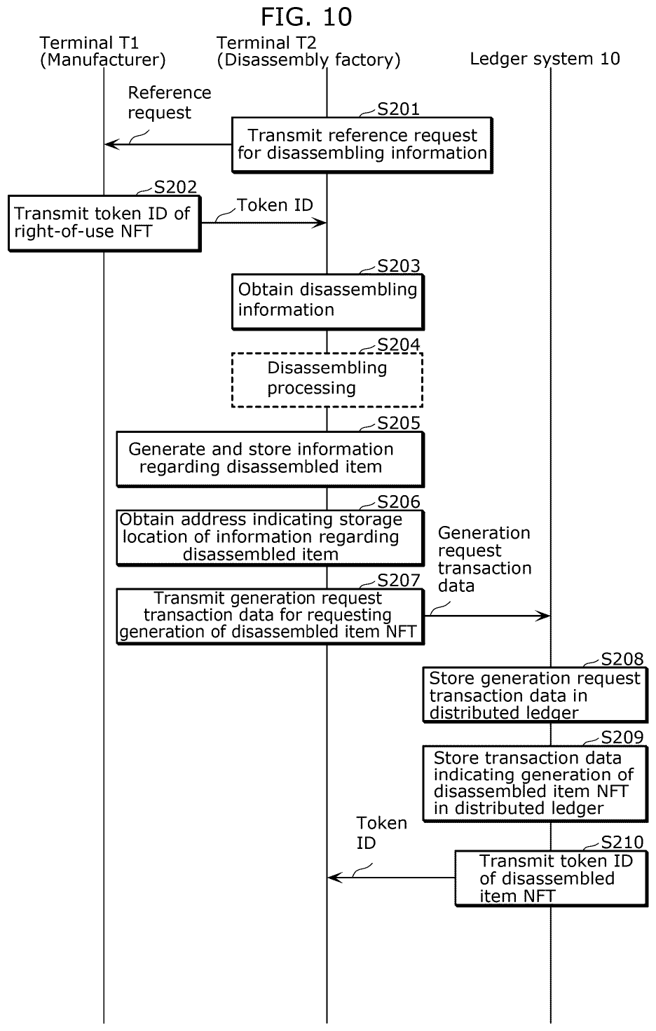

FIG. 10 is a sequence diagram illustrating the generation processing of generating the trace NFT corresponding to the disassembled item in the present embodiment. A series of steps illustrated in FIG. 10 is executed before the disassembling processing is performed on the product in the disassembly factory.

At the time when step S201 is executed, the product to be subjected to the disassembling processing is in the disassembly factory. Note that the product to be subjected to the disassembling processing need not be in the disassembly factory at the time when step S201 is executed. Even in this case, the product needs to be in the disassembly factory at the time when the disassembling processing is performed in step S204.

In step S201, terminal T2 transmits a reference request for the disassembling information to terminal T1. Terminal T1 receives the transmitted reference request. The reference request for the disassembling information is information for requesting the reference to disassembling information on the product to be subjected to the disassembling processing.

In step S202, terminal T1 transmits the token ID of a right-of-use NFT to terminal T2 in response to the receiving of the reference request in step S201. Terminal T2 receives the transmitted token ID. The token ID of a right-of-use NFT can be the token ID obtained in step S107 (see FIG. 9).

In step S203, using the token ID received in step S202, terminal T2 refers to metadata on the right-of-use NFT, thus obtaining the disassembling information. To obtain the disassembling information, the address indicating the storage location of right information included in metadata is used. The disassembling information can be disassembling information that is stored in storage device 5 by terminal T1 in step S102 (see FIG. 9).

In step S204, the disassembling processing is performed on the product in the disassembly factory, using the disassembling information obtained by terminal T2 in step S203. Through the disassembling processing, the disassembled item is generated.

In step S205, terminal T2 generates information regarding the disassembled item generated through the disassembling processing in step S204 and stores the generated information in storage device 5.

In step S206, terminal T2 obtains the address indicating a storage location where the information regarding the disassembled item is stored in step S205. The address is, for example, a URI. More specifically, the address may be a URL.

In step S207, terminal T2 transmits generation request transaction data for requesting the generation of a disassembled item NFT that is a trace NFT corresponding to the disassembled item to ledger system 10. Ledger system 10 receives the transmitted generation request transaction data. The generation request transaction data includes the address that is obtained by terminal T2 in step S206 and indicates the storage location of the information regarding the disassembled item.

In step S208, ledger system 10 stores the generation request transaction data received in step S207 in distributed ledger 111.

In step S209, ledger system 10 generates the disassembled item NFT using the generation request transaction data in response to the storing of the generation request transaction data in distributed ledger 111 in step S208. Generating the disassembled item NFT includes storing transaction data indicating the generation of the disassembled item NFT in distributed ledger 111. Metadata in the disassembled item NFT includes the address indicating the storage location of the information regarding the disassembled item.

In step S210, ledger system 10 transmits the token ID of the disassembled item NFT generated in step S209 to terminal T2. Terminal T2 receives the transmitted token ID. Note that ledger system 10 may perform the transmission of the token ID as a response to the reception of the generation request transaction data in step S207.

Note that the processing in steps S209 to S210 may be executed by means of a smart contract based on the storage of the generation request transaction data in distributed ledger 111 in step S208. In this case, the generation request transaction data includes instructions to execute the smart contract for executing the processing, and executor 103 can execute the processing according to the instructions in response to the storing of the generation request transaction data in distributed ledger 111 (step S208).

Through the series of steps illustrated in FIG. 10, the trace NFT corresponding to the disassembled item is generated when the disassembled item is generated by the disassembly factory.

### (Transfer Processing of Transferring Disassembled Item NFT)

The transfer processing of transferring a disassembled item NFT corresponding to a disassembled item generated by the disassembly factory to the recycling factory will be described.

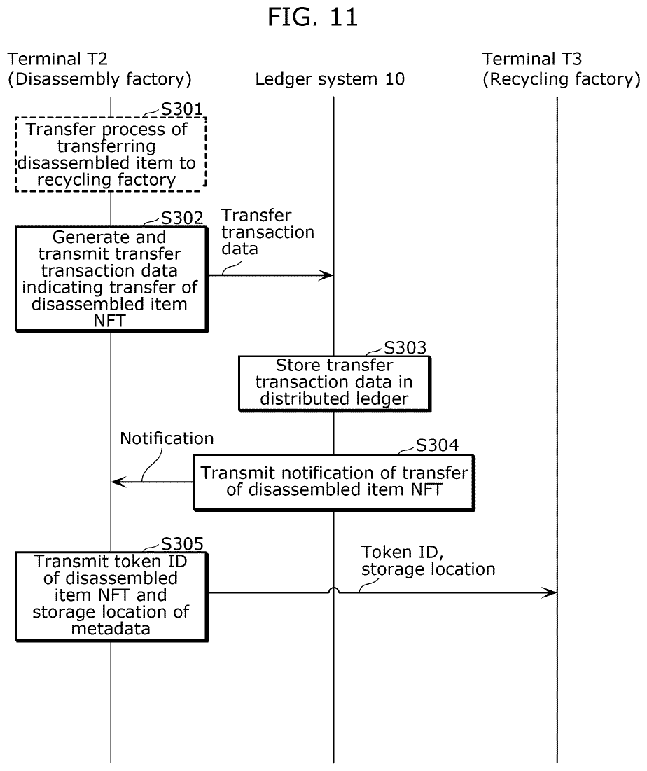

FIG. 11 is a sequence diagram illustrating the transfer processing of transferring a trace NFT corresponding to a disassembled item in the present embodiment.

In step S301, the transfer processing of transferring the disassembled item from the disassembly factory to the recycling factory is executed. The transfer processing can include, for example, transporting the disassembled item from the disassembly factory to the recycling factory and changing the information indicating the owner of the disassembled item from the disassembly factory to the recycling factory.

In step S302, terminal T2 generates transfer transaction data for the transfer of the disassembled item NFT and transmits the transfer transaction data to ledger system 10. Ledger system 10 receives the transmitted transfer transaction data.

In step S303, ledger system 10 stores the transfer transaction data received in step S302 in distributed ledger 111.

In step S304, ledger system 10 transmits the notification of the transfer of the disassembled item NFT to terminal T2. Terminal T2 receives the transmitted notification.

In step S305, terminal T2 transmits the token ID of the disassembled item NFT and the storage location of metadata to terminal T3. Terminal T3 receives the transmitted token ID of the disassembled item NFT and the transmitted storage location of metadata.

Through the series of steps illustrated in FIG. 11, the disassembled item generated by the disassembly factory is transferred to the recycling factory, and the disassembled item NFT corresponding to the disassembled item is transferred to the recycling factory.

### (Generation Processing of Generating Trace NFT Corresponding to Recycled Item)

The generation processing of generating a trace NFT corresponding to a recycled item will be described below. Here will be described the processing of generating, when the recycled item is generated through the recycling of a disassembled item in the recycling factory, a trace NFT corresponding to the recycled item in response to a request from terminal T3 of a user of the recycling factory.

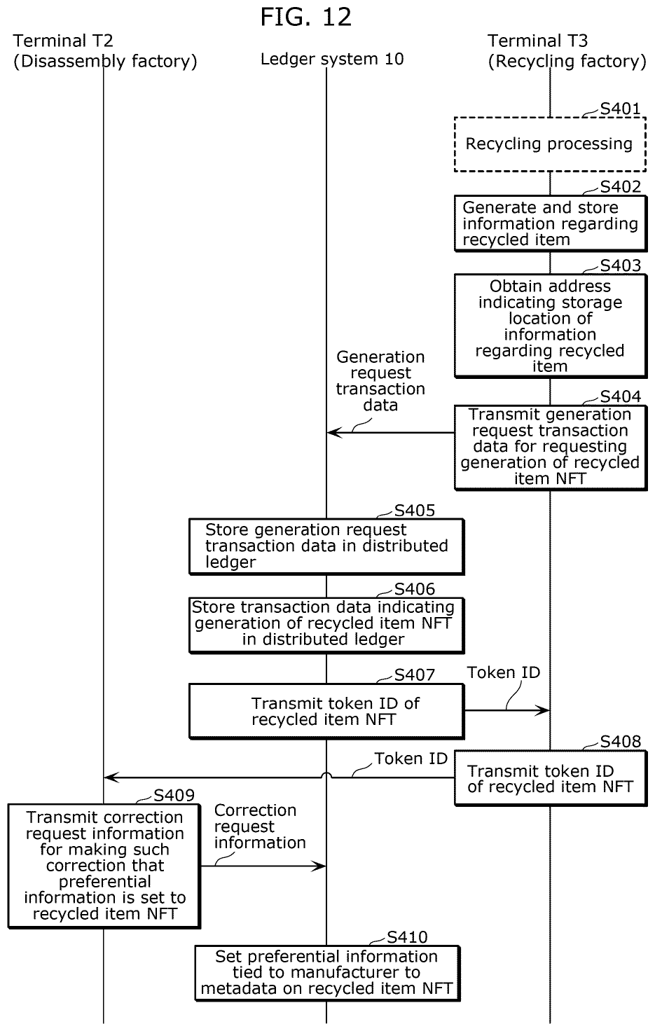

FIG. 12 is a sequence diagram illustrating the generation processing of generating the trace NFT corresponding to the recycled item in the present embodiment.

In step S401, the recycled item is obtained by the recycling processing performed on the disassembled item. The disassembled item to be subjected to the recycling processing can be the disassembled item transferred from the disassembly factory to the recycling factory in step S301 (see FIG. 11).

In step S402, terminal T3 generates information regarding the recycled item generated through the recycling processing in step S401 and stores the generated information in storage device 5.

In step S403, terminal T3 obtains the address indicating a storage location where the information regarding the recycled item is stored in step S402. The address is, for example, a URI. More specifically, the address may be a URL.

In step S404, terminal T3 transmits generation request transaction data for requesting the generation of a recycled item NFT that is a trace NFT corresponding to the recycled item to ledger system 10. Ledger system 10 receives the transmitted generation request transaction data. The generation request transaction data includes the address that is obtained by terminal T3 in step S403 and indicates the storage location of the information regarding the recycled item.

In step S405, ledger system 10 stores the generation request transaction data received in step S404 in distributed ledger 111.

In step S406, ledger system 10 generates the recycled item NFT using the generation request transaction data in response to the storing of the generation request transaction data in distributed ledger 111 in step S405. Generating the recycled item NFT includes storing transaction data indicating the generation of the recycled item NFT in distributed ledger 111. Metadata in the recycled item NFT includes the address indicating the storage location of the information regarding the recycled item.

In step S407, ledger system 10 transmits the token ID of the recycled item NFT generated in step S406 to terminal T3. Terminal T3 receives the transmitted token ID. Note that ledger system 10 may perform the transmission of the token ID as a response to the reception of the generation request transaction data in step S404.

In step S408, terminal T3 transmits the token ID of the recycled item NFT received in step S407 to terminal T2. Terminal T2 receives the transmitted token ID.

In step S409, using the token ID of the recycled item NFT received in step S408, terminal T2 transmits a correction request information for correcting the recycled item NFT to ledger system 10. The correction request information is information for requesting such a correction that preferential information is set to the recycled item NFT. The correction request information includes the token ID of the recycled item NFT and identification information on a manufacturer. Ledger system 10 receives the transmitted correction request information.

In step S410, ledger system 10 corrects metadata on the recycled item NFT in response to the receiving of the correction request information in step S409. Specifically, ledger system 10 corrects the metadata on the recycled item NFT in such a manner as to set preferential information tied to the manufacturer indicated by the identification information included in the correction request information to the metadata on the recycled item NFT indicated by the token ID included in the correction request information.

Note that the processing in step S406 to S407 may be executed by means of a smart contract based on the storage of the generation request transaction data in distributed ledger 111 in step S405. In this case, the generation request transaction data includes instructions to execute the smart contract for executing the processing, and executor 103 can execute the processing according to the instructions in response to the storing of the generation request transaction data in distributed ledger 111 (step S405).

Note that although the above describes the case where the processing in step S402 and its subsequent steps illustrated in FIG. 12 is executed after the recycling processing in step S401 has been completed (i.e., after the recycled item has been generated), the processing in step S402 and its subsequent steps illustrated in FIG. 12 may be executed before the recycled item is generated. In this case, terminal T3 can execute the processing in step S402 and its subsequent steps using the information indicating a recycled item that is expected to be generated from the disassembled item through the recycling processing (a resin, a metal, or a substrate, etc.). Note that, in this case, terminal T3 needs to include in advance at least a part of the information indicating what recycled item (a resin, a metal, a substrate, etc.) is to be generated from the disassembled item.

Through the series of steps illustrated in FIG. 12, the trace NFT corresponding to the recycled item is generated when the recycled item is generated by the recycling factory.

### (Generation Processing of Generating Preferential NFT)

The processing of generating a preferential NFT equivalent to a right to preferentially purchase a recycled item generated from a disassembled item will be described below.

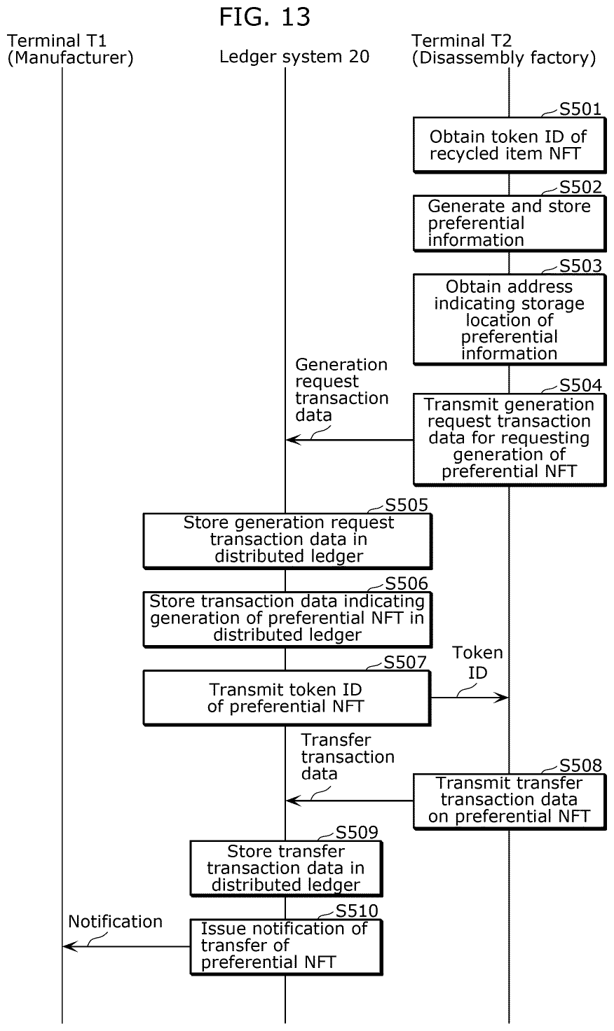

FIG. 13 is a sequence diagram illustrating the generation processing of generating a preferential NFT in the present embodiment.

In step S501, terminal T2 executes obtaining processing of obtaining the token ID of a disassembled item NFT and the token ID of a recycled item NFT. Through the obtaining processing, terminal T2 can obtain the token ID of the disassembled item NFT and the token ID of the recycled item NFT from terminal T3. The token ID of the disassembled item NFT can be the token ID received by terminal T2 in step S210 (see FIG. 10). The token ID of the recycled item NFT can be the token ID received by terminal T3 in step S407 (see FIG. 12).

In step S502, terminal T2 generates preferential information and stores the generated preferential information in storage device 5. The preferential information generated by terminal T2 is equivalent to information included in the metadata on the preferential NFT illustrated in FIG. 8.

In step S503, terminal T2 obtains the address indicating the storage location where the preferential information is stored in step S502. The address is, for example, a URI. More specifically, the address may be a URL.

In step S504, terminal T2 transmits generation request transaction data for requesting the generation of the preferential NFT to ledger system 20. Ledger system 20 receives the transmitted generation request transaction data. The generation request transaction data includes at least the address of a distributed ledger storing the recycled item NFT. The generation request transaction data can further include the token ID of the recycled item NFT obtained in step S501 and the address indicating the storage location of the preferential information obtained in step S503.

In step S505, ledger system 20 stores the generation request transaction data received in step S504 in distributed ledger 211.

In step S506, ledger system 20 generates the preferential NFT using the generation request transaction data in response to the storage of the generation request transaction data in distributed ledger 211 in step S505. Generating the preferential NFT includes storing the preferential NFT in distributed ledger 211. More specifically, generating the preferential NFT includes storing transaction data indicating the generation of the preferential NFT in distributed ledger 211. Metadata in the preferential NFT includes the preferential information. Note that the owner of the preferential NFT is the disassembly factory at this time.

In step S507, ledger system 20 transmits the token ID of the preferential NFT generated in step S506 to terminal T2. Terminal T2 receives the transmitted token ID. Note that ledger system 20 may perform the transmission of the token ID as a response to the reception of the generation request transaction data in step S504.

In step S508, using the token ID received in step S507, terminal T2 generates transfer transaction data for the transfer of preferential NFT from the disassembly factory to the manufacturer and transmits the transfer transaction data to ledger system 20. Ledger system 20 receives the transmitted transfer transaction data.

In step S509, ledger system 20 stores the transfer transaction data received in step S508 in distributed ledger 211.

In step S510, ledger system 20 transmits the notification of the transfer of the preferential NFT to terminal T1. Terminal T1 receives the transmitted notification.

Note that terminal T2 may fail to obtain the token ID of the recycled item NFT as a result of the execution of the obtaining processing in step S501. For example, the obtaining of the token ID of the recycled item NFT may fail due to a communication line failure or a malfunction of terminal T3. The obtaining of the token ID of the recycled item NFT may also fail in the case where a block including transaction data indicating the generation of the recycled item NFT is undetermined in the distributed ledger in which the recycled item NFT is managed. Note that the case where the obtaining of the token ID of the recycled item NFT fails also includes the case where the token ID of a correct recycled item NFT in a current state cannot be obtained due to, for example, a change of the address of the distributed ledger in which the recycled item NFT is managed (i.e., tracing chain 30).

In such a case, in step S502, terminal T2 generates preferential information including the information indicating that the token ID of the recycled item NFT is undetermined. Then, in step S506, ledger system 20 generates a preferential NFT including the preferential information as metadata.

Note that the processing in steps S506 to S507 may be executed by means of a smart contract based on the storage of the generation request transaction data in distributed ledger 211 in step S505. In this case, the generation request transaction data includes instructions to execute the smart contract for executing the processing, and executor 203 can execute the processing according to the instructions in response to the storing of the generation request transaction data in distributed ledger 211 (step S505).

Through the series of steps illustrated in FIG. 13, the preferential NFT equivalent to the right to preferentially purchase the recycled item generated from the disassembled item is generated.

### (Purchasing Processing of Purchasing Recycled Item Using Preferential NFT)

The processing of purchasing, using a preferential NFT, a recycled item originating from a product manufactured by a manufacturer will be described below.

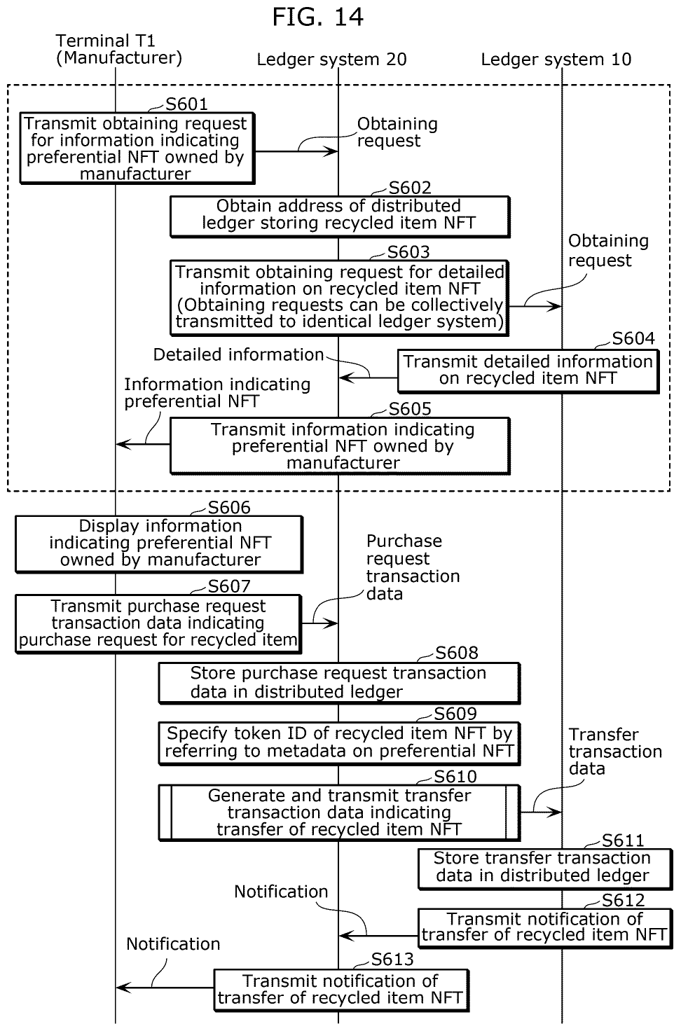

FIG. 14 is a sequence diagram illustrating the purchasing processing of purchasing a recycled item using a preferential NFT in the present embodiment.

In step S601, terminal T1 transmits an obtaining request for information indicating the preferential NFT owned by the manufacturer to ledger system 20. The obtaining request includes the token ID of the preferential NFT, which is the target of the obtaining request. Ledger system 20 receives the transmitted obtaining request.

In step S602, in response to the obtaining request received in step S601, ledger system 20 obtains the address of a distributed ledger storing a recycled item NFT corresponding to the recycled item that can be preferentially purchased using the preferential NFT (i.e., tracing chain 30). In the case where there are a plurality of recycled items each being the recycled item described above, ledger system 20 obtains the addresses of distributed ledgers in which recycled item NFTs corresponding to the plurality of recycled items are stored.

In step S603, using the address of the distributed ledger obtained in step S602, ledger system 20 transmits an obtaining request for detailed information on the recycled item NFT to ledger system 10. The obtaining request includes the token ID of the recycled item NFT, which is the target of the obtaining request. Ledger system 10 receives the transmitted obtaining request.

Note that in the case where there are a plurality of recycled items each being the recycled item described above, ledger system 20 transmits obtaining requests for a plurality of corresponding recycled item NFTs, which are recycled item NFTs corresponding to the plurality of recycled items, to ledger system 10 storing the recycled item NFTs. Ledger system 20 transmits the obtaining requests for the plurality of recycled item NFTs individually to ledger system 10 in principle. In the case where a plurality of recycled item NFTs included in the targets of the obtaining requests are stored in the distributed ledger included in an identical ledger system, ledger system 10, the obtaining requests for the plurality of recycled item NFTs can be transmitted collectively to the identical ledger system, ledger system 10. Collectively transmitting the obtaining requests can be, for example, transmitting one communication packet that includes two or more obtaining requests of the obtaining requests. This brings about the effect of reducing communications traffic.

In step S604, in response to the obtaining request received in step S603, ledger system 10 transmits the detailed information on the recycled item NFT to ledger system 20. Ledger system 20 receives the transmitted detailed information. Note that in the case where there are a plurality of recycled items each being the recycled item described above, one or more ledger systems 10 transmit pieces of detailed information on recycled item NFTs corresponding to the plurality of recycled items to ledger system 20. Ledger system 20 receives one or more pieces of detailed information transmitted in this manner.

In step S605, ledger system 20 transmits information indicating the preferential NFT owned by the manufacturer to terminal T1. The transmitted information, which is display

information, includes the information indicating the preferential NFT owned by the manufacturer and further includes detailed information on the recycled item NFT of a recycled item that the manufacturer can preferentially purchase using the preferential NFT (in other words, the one or more pieces of detailed information on the one or more recycled item NFTs received in step S604). The display information will be described in detail later. The transmitting of the information indicating the preferential NFT in step S605 may be performed as a response to the obtaining request received in step S601.

In step S606, terminal T1 displays the information that is received in step S605 and indicates the preferential NFT owned by the manufacturer on the display screen.

In step S607, terminal T1 transmits purchase request transaction data indicating a purchase request for the recycled item that can be preferentially purchased using the preferential NFT to ledger system 20. The recycled item, which is the target of the purchase request, can be specified by, for example, the reception of the selection of the recycled item made by a user who visually checks the information indicating the preferential NFT displayed on the display screen in step S606, as a recycled item that the user intends to purchase. Ledger system 20 receives the transmitted purchase request transaction data.

In step S608, ledger system 20 stores the purchase request transaction data received in step S607 in distributed ledger 211.

In step S609, ledger system 20 obtains the token ID of the recycled item NFT by referring to metadata on the preferential NFT (i.e., preferential information) in response to the storing of the purchase request transaction data in distributed ledger 211 in step S608.

In step S610, ledger system 20 generates transfer transaction data for the transfer of the recycled item NFT from the recycling factory to the manufacturer and transmits the transfer transaction data to ledger system 10. Ledger system 10 receives the transmitted transfer transaction data. At this time, based on the fact that terminal T1 owns the preferential NFT, ledger system 20 causes the processing of transferring the recycled item to the manufacturer to be preferentially performed. Note that causing the processing of the transfer to be preferentially performed can include, for example, performing the processing earlier than another party that intends to purchase the identical target or performing the processing at a lower price than the other party.

In step S611, ledger system 10 stores the transfer transaction data received in step S610 in distributed ledger 111.

In step S612, ledger system 10 transmits the notification of the transfer of the recycled item NFT to ledger system 20. Ledger system 20 receives the transmitted notification.

In step S613, ledger system 20 transmits the notification of the transfer of the recycled item NFT to terminal T1. Terminal T1 receives the transmitted notification.

Note that the processing in steps S609 to S613 may be executed by means of a smart contract based on the storage of the purchase request transaction data in distributed ledger 211 in step S608. In this case, the purchase request transaction data includes instructions to execute the smart contract for executing the processing, and executor 203 can execute the processing according to the instructions in response to the storing of the purchase request transaction data in distributed ledger 211 (step S608).

Through the series of steps illustrated in FIG. 14, the manufacturer can preferentially purchase the recycled item using the preferential NFT.

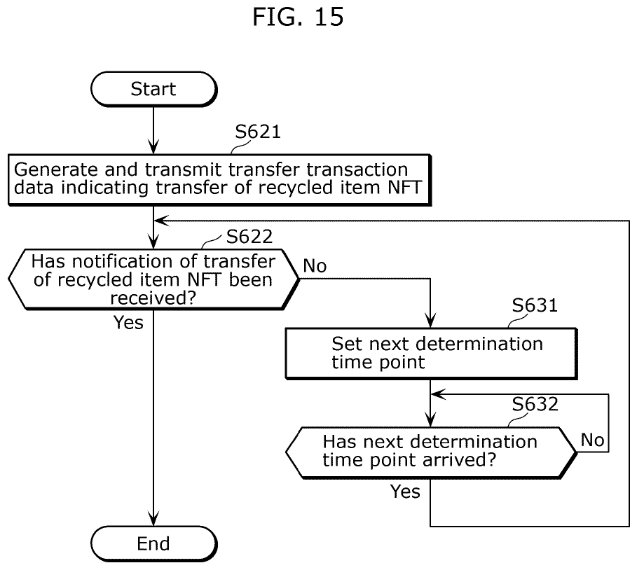

Note that when ledger system 20 does not receive the notification of the transfer of the recycled item NFT in step S611, ledger system 20 may check the notification of the transfer of the recycled item NFT a plurality of times. An example of such processing will be described with reference to FIG. 15.

FIG. 15 is a flowchart illustrating processing performed by ledger system 20 in the processing of using a preferential NFT in the present embodiment. The processing illustrated in FIG. 15 is processing equivalent to steps S609 to S611 illustrated in FIG. 14.

In step S621, ledger system 20 generates transfer transaction data for the transfer of the recycled item NFT and transmits the transfer transaction data to ledger system 10. Ledger system 10 receives the transmitted transfer transaction data.

In step S622, ledger system 20 determines whether the notification of the transfer of the recycled item NFT has been received. When determining that the notification of the transfer of the recycled item NFT has been received (Yes in step S622), ledger system 20 finishes the processing illustrated in FIG. 15 and proceeds to step S612 (see FIG. 14); otherwise (No in step S622), ledger system 20 proceeds to step S631.

In step S631, ledger system 20 sets the time point when the determination is to be performed next time (also referred to as a next determination time point).

In step S632, ledger system 20 determines whether the next determination time point has arrived. When determining that the next determination time point has arrived (Yes in step S632), ledger system 20 proceeds to step S622; otherwise (No in step S632), ledger system 20 executes step S632 again. That is, ledger system 20 stays in a stand-by state in step S632 until the next determination time point arrives.

Note that the processing of setting the next determination time point in step S631 is equivalent to the processing of scheduling the execution of the determination for a later time point. In this case, another process may concurrently perform the processing in FIG. 14 before the next determination time point arrives.

By performing the processing illustrated in FIG. 15, the rest of the processing can be executed even when ledger system 20 does not receive the notification of the transfer of the recycled item NFT. In this case, ledger system 20 checks the reception of the notification of the transfer of the recycled item NFT a plurality of times, and when receiving the notification, ledger system 20 can continue the processing, determining that the transfer of the recycled item NFT is completed.

Note that, in step S603, ledger system 20 can transmit obtaining requests for pieces of detailed information about pieces of information regarding a plurality of preferential NFTs received from terminals T1 of a plurality of manufacturers to ledger system 10. The processing of transmitting the obtaining requests received from terminals T1 of the plurality of manufacturers to ledger system 10 will be described below.

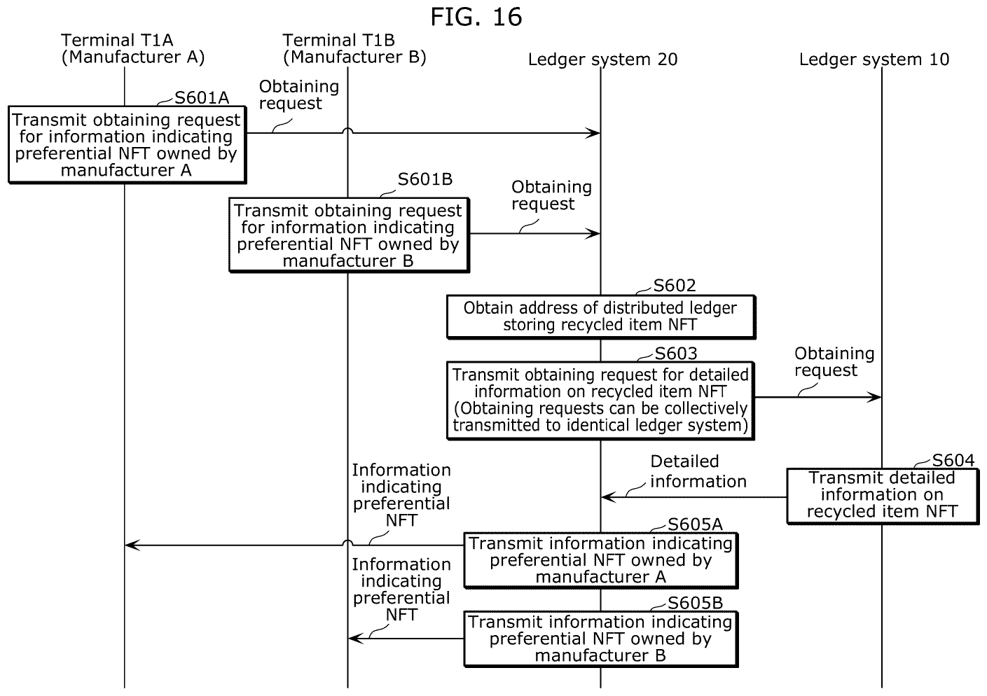

FIG. 16 is a sequence diagram illustrating an example of the obtaining processing of obtaining the pieces of detailed information in the present embodiment. Note that the sequence diagram illustrated in FIG. 16 is equivalent to processing enclosed in a broken-line frame in FIG. 14 (i.e., the processing in steps S601 to S605).

Here, assume that there are two manufacturers: manufacturers A and B. The terminal of manufacturer A is terminal T1A, and the terminal of manufacturer B is terminal T1B.

In step S601A, terminal T1A transmits an obtaining request for information indicating a preferential NFT owned by manufacturer A to ledger system 20. The obtaining request includes the token ID of the preferential NFT, which is the target of the obtaining request. Ledger system 20 receives the transmitted obtaining request.

In step S601B, terminal T1B transmits an obtaining request for information indicating a preferential NFT owned by manufacturer B to ledger system 20. The obtaining request includes the token ID of the preferential NFT, which is the target of the obtaining request. Ledger system 20 receives the transmitted obtaining request.

In step S602, in response to each of the obtaining requests received in steps S601A and S601B, ledger system 20 obtains the address of a distributed ledger storing a recycled item NFT corresponding to a recycled item that can be preferentially purchased using the preferential NFT. In the case where there are a plurality of recycled items each being the recycled item described above, ledger system 20 obtains the addresses of distributed ledgers in which recycled item NFTs corresponding to the plurality of recycled items are stored.

Steps S603 to S604 are the same as the steps with the same name illustrated in FIG. 14. Note that in the case where a plurality of recycled item NFTs included in the targets of the obtaining requests received from terminal T1A and terminal T1B are stored in the distributed ledger included in an identical ledger system, ledger system 10, the obtaining requests for the plurality of recycled item NFTs can be transmitted collectively to the identical ledger system, ledger system 10. This brings about the effect of reducing communications traffic.

In step S605A, ledger system 20 transmits information indicating the preferential NFT owned by manufacturer A to terminal T1A. The transmitted information, which is display information, includes the information indicating the preferential NFT owned by manufacturer A and further includes detailed information on the recycled item NFT of a recycled item that can be preferentially purchased using the preferential NFT (in other words, detailed information on the recycled item NFT of the recycled item that manufacturer A can preferentially purchase using the preferential NFT out of the one or more pieces of detailed information on the one or more recycled item NFTs received in step S604).

In step S605B, ledger system 20 transmits information indicating the preferential NFT owned by manufacturer B to terminal T1B. The transmitted information, which is display information, includes the information indicating the preferential NFT owned by manufacturer B and further includes detailed information on the recycled item NFT of a recycled item that can be preferentially purchased using the preferential NFT (in other words, detailed information on the recycled item NFT of the recycled item that manufacturer B can preferentially purchase using the preferential NFT out of the one or more pieces of detailed information on the one or more recycled item NFTs received in step S604).

Thereafter, terminal T1A and terminal T1B can individually execute the processing in step S606 and its subsequent steps illustrated in FIG. 14.

Through the processing illustrated in FIG. 16, ledger system 20 can transmit the obtaining requests for the pieces of detailed information about the pieces of information regarding the plurality of preferential NFTs received from terminals T1 of the plurality of manufacturers to ledger system 10 and can continue the processing.

An example of displaying owned NFTs (specifically, preferential NFTs or recycled item NFTs) will be described below.

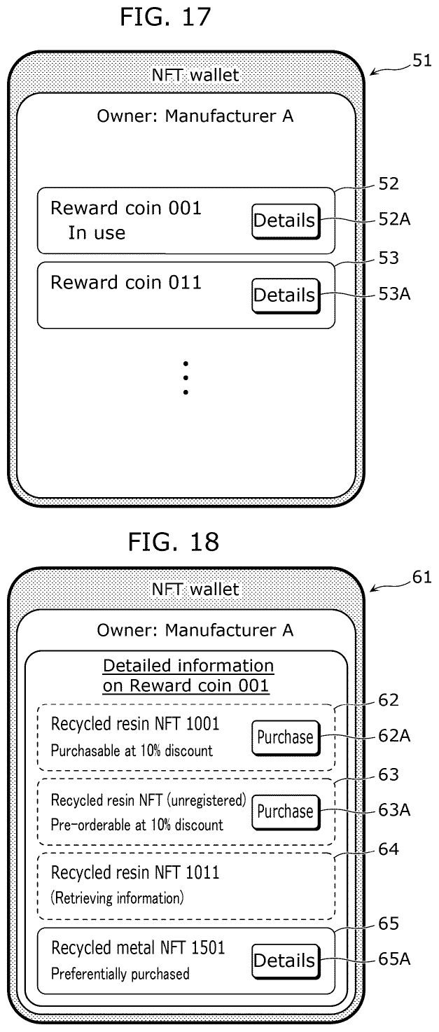

FIG. 17 is an explanatory diagram illustrating an example of a display image displaying a preferential NFT in the present embodiment. Image 51 illustrated in FIG. 17 is an example of a display image that terminal T1 displays on its display screen in step S606 (see FIG. 14), for example.

Image 51 illustrates the list of preferential NFTs owned by manufacturer A. Image 51 includes image 52 illustrating “Reward coin 001” and image 53 illustrating “Reward coin 011” as the preferential NFTs owned by manufacturer A.

Image 52 includes button image 52A for proceeding to the display of detailed information on “Reward coin 001.” Image 53 includes button image 53A for proceeding to the display of detailed information on “Reward coin 011.”

By visually checking image 51, a user of manufacturer A can learn the preferential NFTs owned by manufacturer A. In addition, the user can proceed to the display of the detailed information on a preferential NFT to select a preferential NFT to use for purchasing a recycled item.

FIG. 18 is an explanatory diagram illustrating an example of a display image displaying detailed information on a preferential NFT in the present embodiment. Image 61 illustrated in FIG. 18 is an example of a display image displaying detailed information on “Reward coin 001,” which is the preferential NFT. Image 61 is an example of an image displayed when button image 52A (see FIG. 17) is operated, for example.

Image 61 is an example of a display image displaying detailed information on “Reward coin 001,” which is the preferential NFT.

Image 61 includes image 62 illustrating “Recycled resin NFT 1001” as a recycled item NFT that can be purchased using “Reward coin 001,” which is the preferential NFT, image 63 illustrating “Recycled resin NFT (unregistered),” image 64 illustrating “Recycled resin NFT 1011,” and image 65 illustrating “Recycled metal NFT 1501.”

Here, the recycled resin NFT illustrated by image 63 is an example of an NFT that is not yet registered in tracing chain 30, and image 63 is given the character string “(unregistered)” indicating to that effect. This is equivalent to an example of the display in the case where the recycled item NFT is not yet registered in tracing chain 30, based on the case where the processing in step S402 and its subsequent steps (see FIG. 12) is executed before a recycled item is generated.

Recycled resin NFT 1011 illustrated in image 64 is an example of an NFT for which obtaining of information is not completely finished, and image 64 is given the character string “(Retrieving information)” indicating to that effect. This is equivalent to an example of the display in the case where the notification of the transfer of the recycled item NFT is being received, based on the case where the notification of the transfer is not yet received in FIG. 15, for example.

Images 62 and 63 include button images 62A and 63A for executing purchasing processing in which manufacturer A purchases “Recycled resin NFT 1001” and “Recycled resin NFT (unregistered),” respectively. When an operation performed by the user on button image 62A or 63A for executing the purchasing processing is received, the transmission of a purchase request (step S607 in FIG. 14) is executed as the purchasing processing of purchasing a recycled item being the target of the operation.

Note that image 64 includes no button image for executing the purchasing processing because information about recycled resin NFT 1011 is not completely obtained.

Image 65 includes button image 65A for proceeding to the display of detailed information on “Recycled metal NFT 1501,” which manufacturer A has already preferentially purchased.

By visually checking image 61, the user of manufacturer A can select a recycled item that the user intends to purchase. By operating a purchase button for the recycled item that the user intends to purchase, the user can purchase the recycled item. In this case, terminal T1 transmits purchase request transaction data, and the purchasing processing of purchasing the recycled item is executed (see steps S607 to S613, FIG. 14).

Note that the display image displaying the preferential NFT may be the display image also displaying a recycled item NFT.

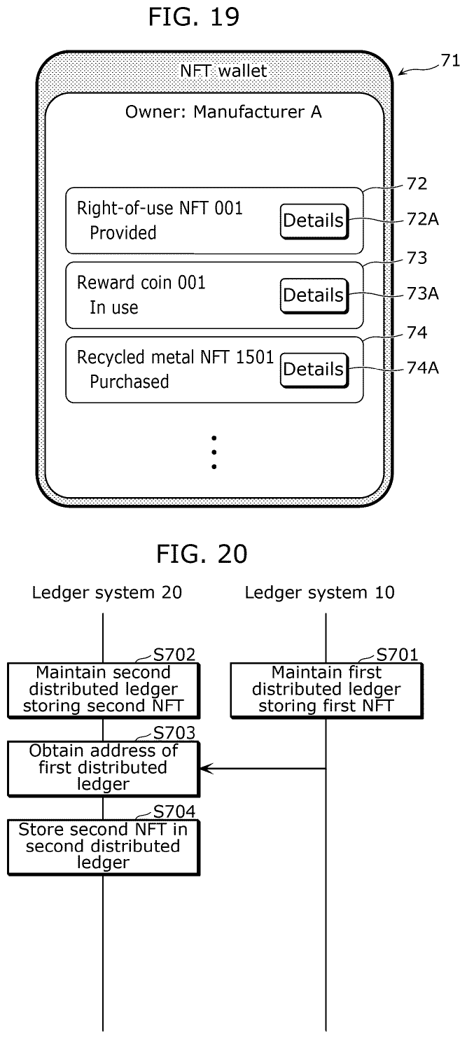

FIG. 19 is an explanatory diagram illustrating an example of a display image displaying an NFT in the present embodiment.

Image 71 illustrated in FIG. 19 is an example of a display image displaying NFTs owned by manufacturer A.

Image 71 illustrates the list of NFTs owned by manufacturer A. Image 71 includes image 72 illustrating “Right-of-use NFT 001,” image 73 illustrating “Reward coin 001,” and image 74 illustrating “Recycled metal NFT 1501” as the NFTs owned by manufacturer A. Image 72 includes button image 72A for proceeding to the display of detailed information on “Right-of-use NFT 001.” Image 73 includes button image 73A for proceeding to the display of detailed information on “Reward coin 001.” Image 74 includes button image 74A for proceeding to the display of detailed information on “Recycled metal NFT 1501.”

### Variation of Embodiment

In the present variation, examples of an information processing system that encourages the effective use of resources that are different from those in the embodiment will be described.

The configuration of the information processing system in the present variation is the same as the configuration of the information processing system in the embodiment.

FIG. 20 is a sequence diagram illustrating processing performed by the information processing system in the present variation.

In step S701, ledger system 10 maintains the first distributed ledger storing the first NFT. The first NFT is an NFT associated one-to-one with an item. The first distributed ledger is, for example, tracing chain 30 (see FIG. 6).

In step S702, ledger system 20 maintains the second distributed ledge storing a second NFT. The second NFT is an NFT associated with life cycle information, which is information regarding the life cycle of an item. The second distributed ledge is, for example, circulation encouraging chain 40 (see FIG. 6).

In step S703, ledger system 20 obtains the address of the first distributed ledger. The processing in step S703 is equivalent to step S504 (see FIG. 13).

In step S704, ledger system 20 stores the second NFT in the second distributed ledge. The second NFT includes at least the address of the first distributed ledger obtained in step S703. The processing in step S704 is equivalent to step S506 (see FIG. 13).

This enables the information processing system to encourage the effective use of resources.

### (Description of Distributed Ledger System)

Ledger system 10 or 20 in the above description (also referred to as a distributed ledger system) will be described in detail below.

The distributed ledger system is a system that stores and maintains information by means of a peer to peer (P2P) network technique for a plurality of nodes connected together. Each of the nodes is an information processing device in which a processor (e.g., a CPU) executes a program using a memory to perform predetermined processing.

In the distributed ledger system, the plurality of nodes identical copies of information and continuously maintain synchronize the information in an autonomous and distributed manner. This enables the distributed ledger system to store information appropriately while substantially preventing the information from being tampered with, without a privileged node (e.g., a centralized server or a server in a client-server model).

A device to access a distributed ledger is only required to access any one of the plurality of nodes included in the distributed ledger system. In other words, the device need not access a few devices such as centralized servers. Therefore, the concentration of a communication load or processing load on a centralized server, which can occur in a centralized system, is avoided. This produces such advantages that the resources of the nodes (the CPUS, the memories, etc.) are not required to have particularly high-performance specifications, and that communication lines to which the nodes are connected are not required to have particularly large communication capacities. This enables the distributed ledger system to be constituted by ordinary (or general-purpose) nodes or communication lines and can contribute to the effect of reducing necessary computer resources or communication resources or reducing the costs necessary for nodes or communication lines.

In addition, a distributed ledger system is capable of storing information with high fault tolerance or allowing information to be referred to with high fault tolerance. The reason for this is as follows. A distributed ledger system stops if a plurality of nodes included in the distributed ledger system all stop. However, it is rare for the distributed ledger system to stop because it is rare for all of the plurality of nodes to stop. This is considered to be an advantage over a centralized system, which can fail to store information or fail to allow information to be referred to when stopping.

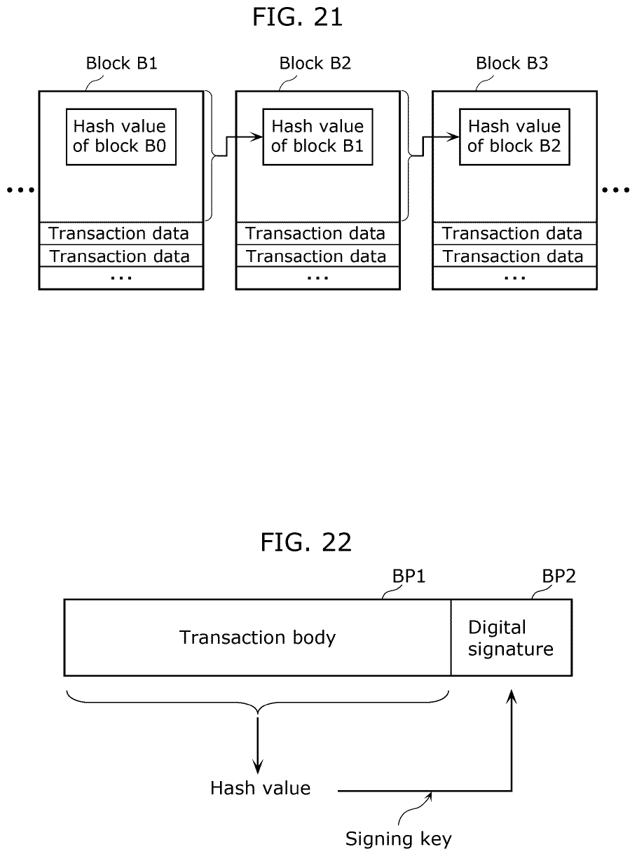

With reference to FIG. 21 to FIG. 25, the data structure of a distributed ledger, the execution of a smart contract, and the data structure of an NFT will be described.

FIG. 21 is an explanatory diagram illustrating the data structure of a blockchain, which is an example of the distributed ledger.

In the blockchain, blocks, which are recording units of the blockchain, are connected to form a chain. Each of the blocks includes a plurality of pieces of transaction data and the hash value of its previous block.

FIG. 21 illustrates blocks B1, B2, and B3 included in the blockchain.

For example, block B2 includes the hash value of block B1, the previous block. The hash value of block B1 is a hash value calculated by computation performed on the content of block B1 according to a hash algorithm.

Block B3 includes a hash value calculated from the plurality of pieces of transaction data included in block B2 and the hash value of block B1, as the hash value of block B2.

As seen from the above, the blockchain has the configuration in which the blocks each including the content of its previous block in the form of a hash value are connected to form a chain. Thus, the blockchain can effectively prevent tampering with recorded transaction data.

If past transaction data is altered (in other words, tampered with), the hash value of the block including the transaction data differs from the value before the alteration. In this case, in order to make the block including the altered transaction data appear authentic, it is necessary to rebuild all the blocks following the block, which includes the altered transaction data, in the distributed ledger stored in each of multiple servers. This task is extremely difficult in reality. These characteristics can make it substantially impossible to tamper with transaction data included in a blockchain.

Note that, to store transaction data in a blockchain, a node generates a block including the transaction data to be stored and executes processing based on a consensus algorithm for the generated block with the other nodes to reach a consensus with them. When the consensus is reached, the node performs control to store the block in the blockchain. In this manner, a plurality of nodes operating in an autonomous and distributed manner can connect a valid block to the blockchain. As the consensus algorithm, practical byzantine fault tolerance (PBFT) may be used, or proof of work (PoW), proof of stake (POS), or the like may be used. Note that, in the case where Hyperledger fabric is used as an example of a distributed ledger technology, the consensus algorithm need not be executed.

FIG. 22 is an explanatory diagram illustrating the data structure of transaction data.

Transaction data illustrated in FIG. 22 includes transaction body BP1 and digital signature BP2 (will also be referred to simply as a signature). Transaction body BP1 is the data body included in the transaction data. Digital signature BP2 is generated by encrypting the hash value of transaction body BP1 with a signing key of the creator of the transaction data (in other words, a private key).

Using digital signature BP2 included in the transaction data, a node receiving the transaction data can verify whether transaction body BP1 is valid (in other words, it is not tampered with). This can make it substantially impossible to tamper with the data included in transaction body BP1. In addition, by storing the transaction data that has been successfully verified in a blockchain, it is possible to maintain the validity of the transaction data stored in the blockchain.

In the above-described manner, transaction data included in a blockchain are stored in the blockchain in such a manner that the transaction data are linked together using the hash values of the transaction data and hash values of blocks. As a result, the transaction data included in the blockchain are stored and maintained being substantially free from tampering. This is an advantage over a database or a distributed database, in which a collection of data is simply stored.

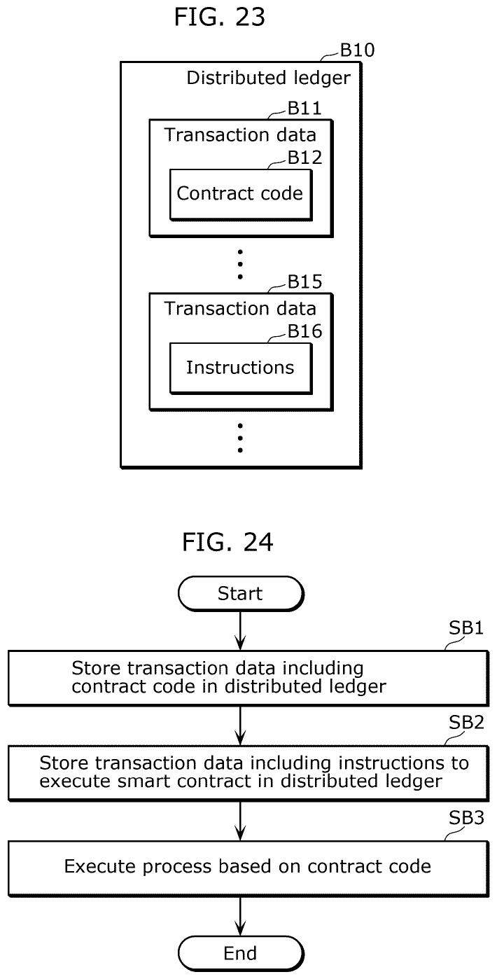

FIG. 23 is an explanatory diagram illustrating transaction data pertaining to the execution of a smart contract. FIG. 24 is an explanatory diagram illustrating processing pertaining to the execution of a smart contract.

With reference to FIG. 23 and FIG. 24, a series of steps pertaining to the execution of the smart contract using a distributed ledger will be described.

In step SB1, a node stores, in distributed ledger B10, transaction data B11 including contract code B12 in which the processing of the smart contract is written. For example, the node obtains transaction data B11 by receiving transaction data B11 from a certain information processing device through communication or by generating transaction data B11 by itself and stores obtained transaction data B11 in distributed ledger B10. Step SB1 is performed before the execution of the smart contract.

In step SB2, the node stores, in distributed ledger B10, transaction data B15 including instructions B16 to execute the smart contract. For example, the node receives transaction data B15 from a certain information processing device through communication and stores received transaction data B15 in distributed ledger B10.

In step SB3, in response to the storing of transaction data B15 including instructions B16 in distributed ledger B10 in step SB2, the node reads contract code B12 from distributed ledger B10 and executes the processing based on contract code B12. The result of the processing can be included in transaction data and stored in distributed ledger B10.

By the series of steps, upon receiving transaction data B15 including instructions B16 to execute the smart contract, the distributed ledger system executes the processing according to instructions B16 automatically (in other words, with no manual operations). Thus, it is possible to execute the processing with high efficiency (in other words, at high speed or in a short time). Achieving highly efficient processing brings about the effect of the reduction in power consumption. In addition, dispensing with manual operations makes it possible to avoid the tampering of information or misconduct by a person, or a human error before it happens. Furthermore, since the result of the processing executed in such a manner is stored in a blockchain, it is substantially impossible to tamper with the result of the processing.

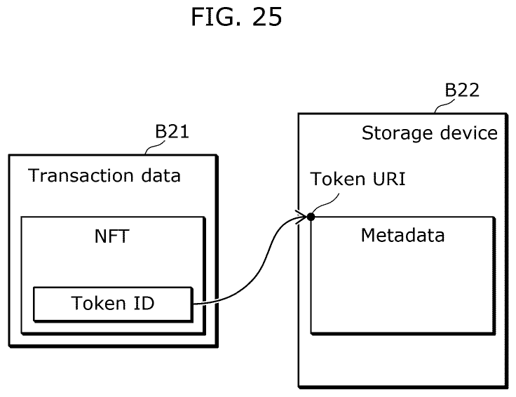

FIG. 25 is an explanatory diagram illustrating the structures of an NFT and metadata. The NFT is a token stored in a distributed ledger. The NFT is a unique token (in other words, a token having non-fungibility). The NFT is standardized according to, but not limited to, for example, Ethereum Request for Comments (ERC) 721. The NFT may conform to a standard different from ERC 721 or may be non-standard (e.g., specific to an organization).

FIG. 25 illustrates transaction data B21 stored in a distributed ledger. Transaction data B21 stores an NFT.

The NFT includes metadata. The metadata can be arranged at a location accessible over a network (e.g., storage device B22). A token URI indicating the location of the metadata is calculated from the token ID of the NFT and a predetermined base URI.

Information managed as the NFT may be included in transaction data B21 or may be included in the metadata. The inclusion of the information managed as the NFT in the metadata produces such an advantage that the amount of information included in transaction data B21 (in other words, information included in a blockchain) can be reduced. In this case, the metadata can be considered to contain the actual conditions of the information managed as the NFT. In the case where an image is managed in the form of an NFT, a URL indicating image data on the image can be managed as the NFT.

Note that each of the constituent elements in the embodiment described above may be configured in the form of an exclusive hardware product, or may be implemented by executing a software program suitable for the constituent element. Each of the constituent elements may be implemented by means of a program executor, such as a CPU and a processor, reading and executing the software program recorded on a recording medium such as a hard disk or a semiconductor memory. Here, the software program for implementing the information processing device and the related technologies according to the embodiment described above is a program described below.

That is, the program causes a computer to execute an information processing method including: obtaining an address of a first distributed ledger in which a first non-fungible token (NFT) is stored, the first NFT being associated one-to-one with an item; and storing, in a second distributed ledger different from the first distributed ledger, a second NFT including the address of the first distributed ledger obtained, the second NFT being associated with life cycle information that is information regarding a life cycle of the item.

Hereinbefore, an information processing method and the related technologies according to one or more aspects have been described based on an exemplary embodiment, but the present disclosure is not limited to this embodiment. Various modifications of the present embodiment as well as forms resulting from combinations of constituent elements in different embodiments that may be conceived by those skilled in the art may be included within the scope of one or more aspects so long as such modifications and forms do not depart from the essence of the present disclosure.

### INDUSTRIAL APPLICABILITY

The present disclosure is applicable to a system that encourages effective use of resources.

1. An information processing method comprising:
obtaining an address of a first distributed ledger in which a first non-fungible token (NFT) is stored, the first NFT being associated one-to-one with an item; and
storing, in a second distributed ledger different from the first distributed ledger, a second NFT including the address of the first distributed ledger obtained, the second NFT being associated with life cycle information that is information regarding a life cycle of the item.

2. The information processing method according to claim 1, wherein
the item is a disassembled item generated by disassembling of a product,
the first NFT is associated one-to-one with the disassembled item as the item, and
the life cycle information includes information regarding the disassembling of the product.

3. The information processing method according to claim 2, wherein
the information regarding the disassembling of the product includes confidential information regarding a design of the product or confidential information regarding the disassembling of the product.

4. The information processing method according to claim 2, wherein
the life cycle information further includes information indicating a recycled item generated by performing recycling processing on the disassembled item.

5. The information processing method according to claim 4, wherein
the second NFT includes identification information identifying a third NFT stored in the first distributed ledger, the third NFT being associated one-to-one with the recycled item.

6. The information processing method according to claim 5, wherein
when the third NFT is not yet stored in the first distributed ledger, the second NFT includes information indicating that the third NFT is not yet stored in the first distributed ledger.

7. The information processing method according to claim 4, further comprising:
causing processing of transferring the recycled item to an owner of the second NFT to be preferentially performed.

8. The information processing method according to claim 1, wherein
the second NFT further includes:
a type of the first distributed ledger; a token standard to which the first NFT conforms; an address of a smart contract used for accessing an NFT stored in the first distributed ledger; and a token identification (ID) of the first NFT in the first distributed ledger.

9. An information processing system comprising:
a first distributed ledger system that manages a first distributed ledger; and
a second distributed ledger system that manages a second distributed ledger, wherein
the first distributed ledger system includes the first distributed ledger in which a first non-fungible token (NFT) is stored, the first NFT being associated one-to-one with an item, and
the second distributed ledger system:
obtains an address of the first distributed ledger; and
stores, in the second distributed ledger different from the first distributed ledger, a second NFT including the address of the first distributed ledger obtained, the second NFT being associated with life cycle information that is information regarding a life cycle of the item.

10. A non-transitory computer-readable recording medium having recorded thereon a program for causing one or more computers to execute the information processing method according to claim 1.
